(19) United States
(12) Patent Application Publication
(10) Pub. No.: US 2015/0178754 A1
(43) Pub. Date: Jun. 25, 2015

(54) INCENTIVE SYSTEM FOR INTERACTIVE CONTENT CONSUMPTION

(71) Applicant: MICROSOFT CORPORATION, REDMOND, WA (US)

(72) Inventors: Zhen Liu, Tarrytown, NY (US); Chien Chih Hsu, Beijing (CN); Jing-Yeu Jaw, Beijing (CN); Yuan-Ching Samuel Shen, Beijing (CN)

(73) Assignee: MICROSOFT CORPORATION, REDMOND, WA (US)

(21) Appl. No.: 14/134,995

(22) Filed: Dec. 19, 2013

(51) Int. Cl. G06Q 30/02

(52) U.S. Cl. CPC G06Q 30/0217

(57) ABSTRACT

Methods, systems and computer program products are described that incentivize users to provide feedback about, consume, and/or interact with content displayed on a user device. In accordance with embodiments, the user provides feedback about content items displayed on the user device, wherein each instance of feedback is classified into one of a plurality of predefined feedback types. Information related to the number of instances of each type of feedback generated by the user is transmitted from the user device to a server where such information is used to determine the value of an incentive to be awarded to the user. The incentives may take the form of credits that are accumulated in association with a user account and an interface may be provided by which the user can redeem the credits to obtain one or more items of value.

### BACKGROUND

Today's Internet content providers have two goals. First, such content providers wish to learn about the preferences of the users that consume their content. By understanding the type of content that a particular user likes and/or dislikes, a content provider can often do a better job delivering content of interest to that user, thereby increasing the chance that the user will interact with the content. For example, if the content provider has a business model that relies on revenue generated by user interaction with display advertisements (“ads”), then it is important that the content provider deliver ads that are likely to be of interest to the user.

Second, today's Internet content providers want to ensure that users spend more time consuming and interacting with their content than they do consuming and interacting with content published by their competitors.

In the past, some content providers have attempted to learn about their users' preferences by obtaining feedback from them about content at a page/screen level. For example, content providers sometime use techniques such as a like/dislike button, a feedback/survey form, or a comments submission box to obtain user feedback about a page/screen currently being displayed to the user. One problem with such conventional approaches is that user participation is usually low. Furthermore, for feedback mechanisms such as feedback/survey forms, the quality of such participation is usually poor.

Content providers may also use cookies to collect information about a user's activities while browsing Web pages and then attempt to infer the user's preferences from such collected information. However, this approach is limited because it is technically difficult to use cookies to measure a user's interest in a particular content item in a scenario in which there are multiple content items concurrently displayed on the same page/screen. Furthermore, cookies can be easily blocked.

To encourage usage, some content providers provide users with awards for conducting particular activities. However, the use of such incentives has heretofore been limited to a small number of scenarios. For example, MICROSOFT® sponsors a reward program in association with their BINGO search engine by which users can receive rewards for conducting searches that use certain keywords. Additionally, certain publishers of applications for mobile devices sponsor rewards programs by which users can be rewarded for attaining certain achievements or conducting certain transactions such as purchases while running an application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are described herein that incentivize users to provide feedback about, consume, and/or interact with content displayed on a user device. In accordance with embodiments, the user explicitly or implicitly provides feedback about content items displayed on a user device, wherein each instance of feedback is classified into one of a plurality of predefined feedback types. Information related to the number of instances of each type of feedback provided by the user is transmitted from the user device to a server where such information is used to determine the value of an incentive to be awarded to the user. In a particular embodiment, the server determines the incentive value based on the number of instances of each type of feedback generated by the user. In a further embodiment, the server determines the incentive value based on the number of instances of each type of feedback generated by the user and a category associated with each content item about which feedback was provided. The incentives may take the form of credits that are accumulated in association with a user account and an interface may be provided by which the user can redeem the credits to obtain one or more items of value.

In particular, a method is described herein. In accordance with the method, an indication of a type of feedback provided by a user with respect to content displayed at a user device is received. A value of an incentive to be awarded to the user is then determined based at least upon the indication of the type of feedback provided by the user with respect to the content. The incentive is then awarded to the user.

In one embodiment of the foregoing method, the type of feedback provided by the user comprises one of a plurality of predefined feedback types, the plurality of predefined feedback types including: a first feedback type that indicates that the user does not like the content; a second feedback type that indicates that the user likes the content and wants to see additional content that is topically related thereto; and a third feedback type that indicates that the user likes the content and wants to see additional information about the content or conduct at least one transaction with respect to the content. In further accordance with such an embodiment, determining the value of the incentive may comprise determining a first incentive value when the indication of the type of feedback indicates the first feedback type, determining a second incentive value when the indication of the type of feedback indicates the second feedback type, and determining a third incentive value when the indication of the type of feedback indicates the third feedback type, wherein the third incentive value is greater than the second incentive value and the second incentive value is greater than the first incentive value.

In another embodiment of the foregoing method, determining the value of the incentive includes determining the value of the incentive based at least upon the indication of the type of feedback provided by the user with respect to the content and a category associated with the content. In further accordance with such an embodiment, determining the value of the incentive based at least upon the indication of the type of feedback provided by the user with respect to the content and the category associated with the content includes determining a first coefficient based on the type of feedback provided by the user with respect to the content, determining a second coefficient based on the category associated with the content, and calculating a number of credits to be awarded to the user by multiplying the first coefficient by the second coefficient.

In yet another embodiment of the foregoing method, awarding the incentive to the user includes adding one or more credits to an accumulated number of credits associated with a user account. In further accordance with such an embodiment, the method may further include one or more of maintaining a limit on a number of credits that can be added to the accumulated number of credits associated with the user account in a particular time period, assigning an incentive step level to the user based at least on the accumulated number of credits associated with the user account, the incentive step level being used to determine a rate at which credits are accumulated to the user account, and providing an interface by which the user can redeem the credits associated with the user account to obtain one or more items of value.

In still another embodiment, the foregoing method may include modeling preferences of the user based at least on the indication of the type of feedback provided by the user with respect to the content.

A system is also described herein. The system includes a network interface and an evaluation engine. The network interface is operable to receive an indication of a type of feedback provided by a user with respect to content displayed at a user device. The evaluation engine is operable to determine a value of an incentive to be awarded to the user based at least upon the indication of the type of feedback provided by the user with respect to the content and to award the incentive to the user.

In one embodiment of the foregoing system, the type of feedback provided by the user comprises one of a plurality of predefined feedback types, the plurality of predefined feedback types including: a first feedback type that indicates that the user does not like the content; a second feedback type that indicates that the user likes the content and wants to see additional content that is topically related thereto; and a third feedback type that indicates that the user likes the content and wants to see additional information about the content or conduct at least one transaction with respect to the content. In further accordance with such an embodiment, the evaluation engine may be operable to determine the value of the incentive by determining a first incentive value when the indication of the type of feedback indicates the first feedback type, determining a second incentive value when the indication of the type of feedback indicates the second feedback type, and determining a third incentive value when the indication of the type of feedback indicates the third feedback type, wherein the third incentive value is greater than the second incentive value and the second incentive value is greater than the first incentive value.

In another embodiment of the foregoing system, the evaluation engine is operable to determine the value of the incentive based at least upon the indication of the type of feedback provided by the user with respect to the content and a category associated with the content. In further accordance with such an embodiment, the evaluation engine may be operable to determine the value of the incentive based at least upon the indication of the type of feedback provided by the user with respect to the content and the category associated with the content by determining a first coefficient based on the type of feedback provided by the user with respect to the content, determining a second coefficient based on the category associated with the content, and calculating a number of credits to be awarded to the user by multiplying the first coefficient by the second coefficient.

In yet another embodiment of the foregoing system, the evaluation engine is operable to award the incentive to the user by adding one or more credits to an accumulated number of credits associated with a user account. In further accordance with such an embodiment, the evaluation engine may be further operable to maintain a limit on a number of credits that can be added to the accumulated number of credits associated with the user account in a particular time period and/or assign an incentive step level to the user based at least on the accumulated number of credits associated with the user account, the incentive step level being used to determine a rate at which credits are accumulated to the user account. In still further accordance with such an embodiment, the foregoing system may further include a redemption engine that is operable to provide an interface by which the user can redeem the credits associated with the user account to obtain one or more items of value.

A computer-readable storage medium comprising computer-executable instructions that, when executed by a processor, perform a method is described herein. The method includes receiving an indication of a type of feedback provided by a user with respect to content displayed at a user device, determining a category associated with the content, determining a value of an incentive based at least upon the indication of the type of feedback provided by the user with respect to the content and the category associated with the content, and awarding the incentive to the user.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of a communication system in which a server device communicates with a user device to provide new content to the user device in response to feedback from a user interacting with displayed content at the user device, according to an example embodiment.

FIG. 2 depicts a flowchart of a method for enabling a user to provide feedback directly on displayed content at a user device, according to an example embodiment.

FIG. 3 depicts a flowchart of a method by which a user can indicate various preferences with respect to displayed content, according to an example embodiment.

FIG. 4 shows an example graphical user interface element that enables a user to indicate various preferences with respect to displayed content, according to an embodiment.

FIG. 5 is a block diagram of a server that is configured to receive a user indicated preference regarding displayed content, and to select new content based thereon, according to an example embodiment.

FIG. 6 depicts a flowchart of a method by which new content may be selected and provided in response to an indication of a categorization of displayed content and a preference regarding the displayed content provided by a user, according to an example embodiment.

FIG. 7 depicts a flowchart of a method by which a server retrieves new content based on a user indicating displayed content is not preferred, according to an example embodiment.

FIG. 8 depicts a flowchart of a method by which a server retrieves new content based on a user indication that similar content to displayed content is desired, according to an example embodiment.

FIG. 9 depicts a flowchart of a method by which a server retrieves new content based on a user indication that content providing additional information for displayed content is desired, according to an example embodiment.

FIG. 10 depicts a flowchart of a method for performing machine learning on user feedback provided on displayed content, according to an example embodiment.

FIGS. 11-24 show examples of displayed content, of interactions by users with the displayed content to provide feedback, and of newly displayed content selected based on the feedback, according to embodiments.

FIG. 25 is a block diagram of an incentive system according to an example embodiment.

FIG. 26 depicts a flowchart of a method for determining a value of an incentive based upon a type of content feedback provided by a user and awarding the incentive to the user, according to an example embodiment.

FIG. 27 depicts a flowchart of a method for determining a value of an incentive to be awarded to a user based at least upon on indication of a type of feedback provided by the user with respect to content, according to an example embodiment.

FIG. 28 depicts a flowchart of a method for determining a value of an incentive based upon a type of feedback provided by a user with respect to content and a category associated with the content and awarding the incentive to the user, according to an example embodiment.

FIG. 29 depicts a flowchart of a method for determining a value of an incentive to be awarded to a user based at least upon on indication of a type of feedback provided by the user with respect to content and a category associated with the content.

FIG. 30 is a block diagram of an exemplary user device in which embodiments may be implemented.

FIG. 31 is a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Methods, systems and computer program products are described herein that incentivize users to provide feedback about, consume, and/or interact with content displayed on a user device. In accordance with embodiments, the user explicitly or implicitly provides feedback about content items displayed on a user device, wherein each instance of feedback is classified into one of a plurality of predefined feedback types. For example, each piece of feedback may be classified as one of a first feedback type that indicates that the user does not like a particular content item (e.g., “No”), a second feedback type that indicates that the user likes the particular content item and wants to see additional content that is topically related thereto (e.g., “More), and a third feedback type that indicates that the user likes the content and wants to see additional information about the content or conduct at least one transaction with respect to the content (e.g., “Deep”). Information related to the number of instances of each type of feedback provided by the user is transmitted from the user device to a server where such information is used to determine the value of an incentive to be awarded to the user. In a particular embodiment, the server determines the incentive value based on a number of instances of each type of feedback generated by the user. In a further embodiment, the server determines the incentive value based on a number of instances of each type of feedback generated by the user and a category associated with each content item about which feedback was provided. The incentives may take the form of credits that are accumulated in association with a user account and an interface may be provided by which the user can redeem the credits to obtain one or more items of value.

By rewarding users for providing feedback about, consuming, and/or interacting with content displayed on a user device, embodiments described herein can be used by a content provider to incentivize users to spend more time consuming and interacting with the content provider's content than they do consuming and interacting with content published by their competitors.

Furthermore, by rewarding users with incentives for providing feedback about, consuming, and/or interacting with content displayed on a user device, embodiments described herein can advantageously motivate a user to perform actions that will better enable a content provider to learn about the user's preferences. This can provide multiple benefits to the content provider. For example, by obtaining a better understanding of users' preferences, the content provider can do a better job serving content that such users are likely to be interested in. This can help to build user loyalty. As another example, by better understanding users' preferences, the content publisher can do a better job connecting advertisers of goods and services to users who are likely to be interested in purchasing those goods and services.

Section II below describes an example user interface (UI) model that can be used by embodiments to enable a user to provide feedback about content, such as content displayed on a user device. Section III describes an incentive system that can be used to provide rewards to users for providing feedback about such content. The incentive system described in Section III can be used in conjunction with the UI model described in Section II, although it is not limited to such an implementation. Section IV describes an example user device and server, each of which may be used to implement embodiments described herein. Section V provides some concluding remarks.

### II. Example UI Model

Today, users consume a great amount of content that is accessible on networks such as the Internet. Examples of such content include images, text, videos, etc. Frequently, when content is displayed on a display screen in the form of a page (e.g., on a webpage), multiple content items may be displayed together in the page, with each content item occupying a portion of the screen. Users that view such content may desire to provide feedback on the displayed content. Current techniques for obtaining feedback on content from users tend to obtain feedback at a page/screen level. For example, techniques such as a like/dislike button, a feedback/survey form, or a comments submission box may be present to obtain user feedback on a current page/screen. Cookies are also used to collect telemetry from users, and to infer the preferences of users. Pre-defined links may also be present that a user can click on to proceed to content displayed on different content pages.

However, intuitive and straightforward techniques do not tend to exist for allowing a user, as a consumer, to express their preference on a specific content item within a page/screen. Furthermore, techniques do not exist for allowing users to change specific content displayed in a portion of a screen to some other content.

For instance, feedback mechanisms provided at the page/screen level, such as the like/dislike buttons, feedback/comment forms, cookies, etc., do not provide a break-down to the content level accuracy easily. When users click on a URL (uniform resource locator) link or advance an application to a next screen, there is no knowledge regarding the preference of the user about the previously displayed content. For example, whether the user clicked to leave a page does not indicate whether the user liked or disliked the content on the page just left. Furthermore, users typically have to finish reading an entire page/screen before leaving the page/screen for a next page/screen. The user cannot change a portion of the displayed page/screen immediately, without leaving.

Embodiments are described in this section that overcome these limitations. For instance, embodiments are described in this section that enable a user to provide feedback at the content level, including providing feedback on a specific content item displayed on a page/screen with multiple content items. Furthermore, the feedback provided by the user may cause the specific content item to be replaced with different content. The different content may be selected based on whether the user feedback indicated the user did not prefer the displayed content item (“No”), indicated the user did prefer the displayed content item and wanted to be displayed similar content (“More”), or that the user did prefer the displayed content item and wanted to be displayed more detailed information regarding the displayed content item (“Deep”). The different content may be displayed in place of the displayed content item, or may be otherwise displayed.

Accordingly, in this section, a new UI (user interface) model is presented that allows users to obtain preferred content through interactions with content providers. For instance, a user may be enabled to quickly obtain desired content by indicating their request through selecting content in the form of text (e.g., keywords, sentences, or paragraphs), images, and/or another form of content from a content provider. With regard to the content, the user may be able to indicate one or more of: “No”—replace this type of content with new (and a possibly different type of) content; “More”—the user likes this type of content and would like to get more relevant content regarding the same (e.g., different photos or news clips of the same topic); and “Deep”—the user likes this content and wants deeper or more detailed information on the content, and/or wants to incur more actions on the current content item. For example, if the content item is an advertisement, the selection by the user of “Deep” may indicate purchase behavior (e.g., the user may be interested in purchasing something related to the content item). In another example, if the content item is a news clip, the selection by the user of “Deep” might trigger a feedback input, or the display of full coverage of the news of the news clip.

Example embodiments are described in the following subsections, including embodiments for enabling users to provide feedback directly on displayed content, for selecting and displaying next content based on the feedback, and for exemplary feedback mechanisms.

A. Example Content Consumption System Embodiments

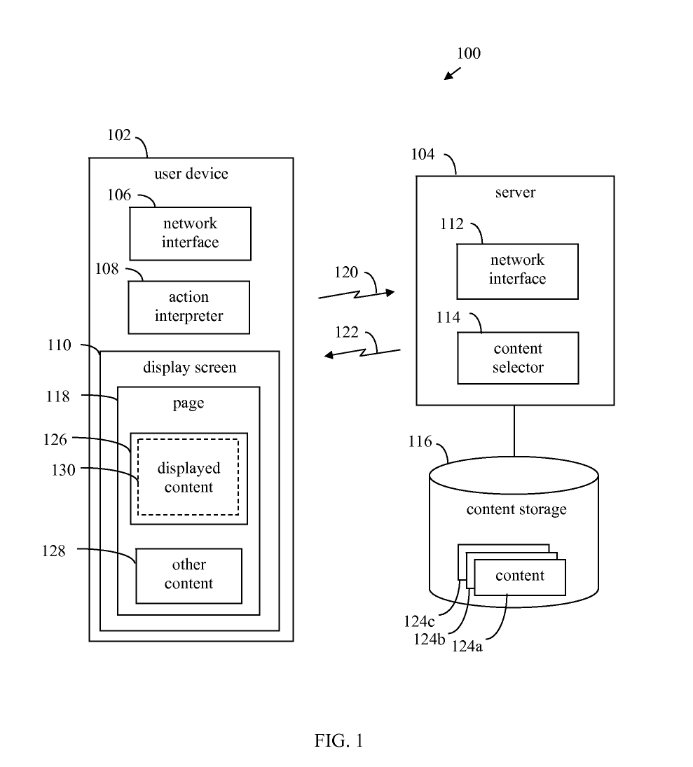

Embodiments may be implemented in devices and servers in various ways. For instance, FIG. 1 is a block diagram of a communication system 100 in which a server 104 communicates with a user device 102 to provide selected content for display at user device 102 in response to user feedback on content displayed at user device 102, according to an example embodiment. As shown in FIG. 1, user device 102 includes a network interface 106, an action interpreter 108, and a display screen 110. Server 104 includes a network interface 112 and a content selector 114. Server 104 includes or is coupled to a content storage 116.

User device 102 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a RIM Blackberry® device, etc.), a wearable computing device (e.g., a smart watch, smart glasses such as Google® Glass™, etc.), or other type of mobile device (e.g., an automobile), or a stationary computing device such as a desktop computer or PC (personal computer). Server 104 may be implemented in one or more computer systems (e.g., servers), and may be mobile (e.g., handheld) or stationary. Server 104 may be considered a “cloud-based” server, may be included in a private or other network, or may be considered network accessible in another way.

As shown in FIG. 1, content storage 116 includes content, such as first content 124a, second content 124b and third content 124c. Each item of stored content may be any type of content, such as textual content (a word, a phrase, a sentence, a paragraph, a document, etc.) or image content (e.g., an image or photo, a video, etc.). Each item of stored content may contain any form of content, such as an advertisement, a news item, etc. Content storage 116 may include one or more of any type of storage mechanism to store content in the form of files or other form, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Network interface 112 of server 104 enables server 104 to communicate over one or more networks, and network interface 106 of user device 102 enables user device 102 to communicate over one or more networks. Examples of such networks include a local area network (LAN), a wide area network (WAN), a personal area network (PAN), or a combination of communication networks, such as the Internet. Network interfaces 106 and 112 may each include one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc.

Display screen 110 of user device 102 may be any type of display screen, such as an LCD (liquid crystal display) screen, an LED (light emitting diode) screen such as an organic LED screen, a plasma display screen, or other type of display screen. Display screen 110 may be integrated in a single housing of user device 102, or may be a standalone display. As shown in FIG. 1, display screen 110 may be used to display content at user device 102. For instance, a user of user device 102 may interact with a user interface of user device 102 to browse content, and cause content to be displayed by display screen 110. For instance, content may be displayed by display screen 110 that is contained in a page 118, such as a web page rendered by a web browser, or content may be displayed in another form by another application.

As shown in FIG. 1, display screen 110 may display displayed content 126 and other content 128. Displayed content 126 and other content 128 may each include one or more content items in the form of textual content or image content. In the example of FIG. 1, displayed content 126 is configured to be able to be interacted with by a user of user device 102 to provide feedback on displayed content 126, according to an embodiment. For example, as shown in FIG. 1, displayed content 126 may include a feedback interface 130 that enables a user to provide feedback on displayed content 126, such as by mouse clicks (e.g., on a displayed pop up menu, one or more virtual buttons, etc.), by touching display screen 110, by motion sensing, by speech recognition, and/or by other user interface interaction. Other content 128 may optionally be present, and may also be configured to be interacted with by a user to provide feedback thereon, or may not be configured to provide feedback.

Action interpreter 108 is configured to interpret the feedback of the user provided with respect to displayed content 126 using feedback interface 130. For example, as described elsewhere herein, the user may provide feedback with respect to displayed content 126 in the form of not preferring displayed content 126 (e.g., not wanting to view displayed content 126, but wanting to display alternative content instead), referred to herein as a feedback selection of “No”; preferring displayed content 126 and wanting to view additional similar content, referred to herein as a feedback selection of “More”; and preferring displayed content 126 and wanting to view additional content that is more descriptive of displayed content 126 and/or conduct a transaction with respect to displayed content 126, referred to herein as a feedback selection of “Deep”. Action interpreter 108 is configured to receive the feedback provided to feedback interface 130 by the user, and provide the feedback to network interface 106 to be transmitted to server 104.

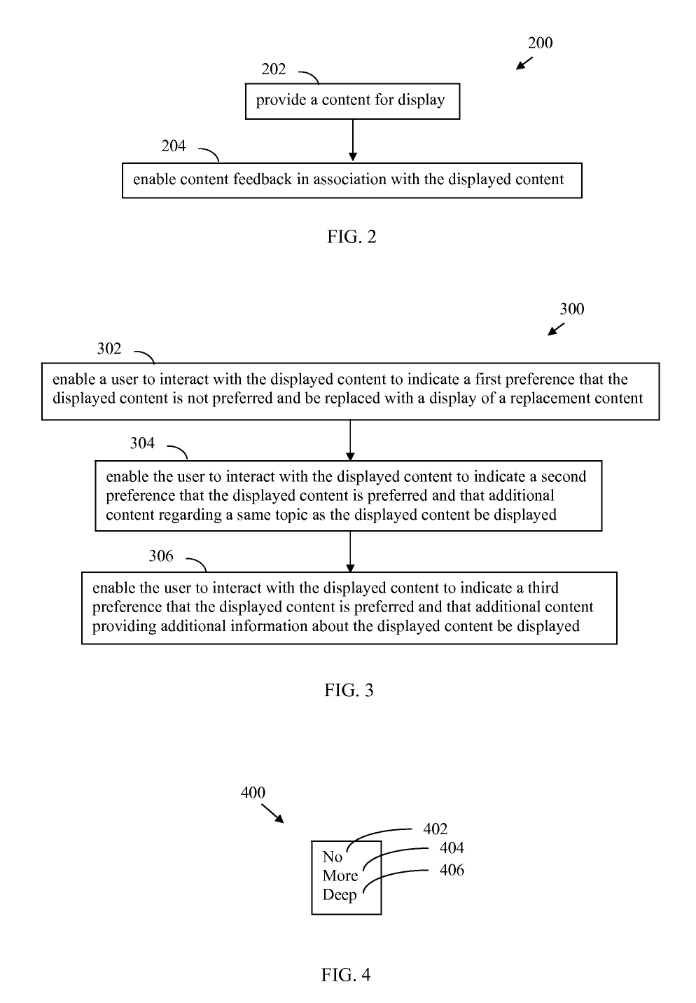

As such, in an embodiment, user device 102 may operate according to FIG. 2. FIG. 2 depicts a flowchart 200 of a method for enabling a user to provide feedback directly on displayed content at a user device, according to an example embodiment. Flowchart 200 is described as follows. Further structural and operational embodiments will be apparent to persons skilled in the relevant art(s) based on the following description.

Flowchart 200 begins with step 202. In step 202, content is provided for display. For instance, as shown in FIG. 1, display screen 110 of user device 102 may display displayed content 126, and optionally may display further content such as other content 128. Such content may be displayed in page 118 or in another form.

In step 204, content feedback is enabled in association with the displayed content. For instance, as described above, user device 102 may provide feedback interface 130 in association with displayed content 126 to enable a user of user device 102 to provide feedback on displayed content 126. Such feedback may be received by action interpreter 108.

FIG. 3 depicts a flowchart 300 of a method by which a user can indicate various preferences with respect to displayed content, according to an example embodiment. For instance, flowchart 300 may be performed as an example of step 204 of flowchart 200 in FIG. 2. Flowchart 300 is described as follows. Further structural and operational embodiments will be apparent to persons skilled in the relevant art(s) based on the following description.

Flowchart 300 begins with step 302. In step 302, a user is enabled to interact with the displayed content to indicate a first preference that the displayed content is not preferred and be replaced with a display of a replacement content. For example, as described above with respect to FIG. 1, the user of user device 102 may be enabled to interact with feedback interface 130 to indicate the “No” preference with respect to displayed content 126.

In step 304, the user is enabled to interact with the displayed content to indicate a second preference that the displayed content is preferred and that additional content regarding a same topic as the displayed content be displayed. For example, as described above, the user of user device 102 may be enabled to interact with feedback interface 130 to indicate the “More” preference with respect to displayed content 126.

In step 306, the user is enabled to interact with the displayed content to indicate a third preference that the displayed content is preferred and that additional content providing additional information about the displayed content be displayed. For example, as described above, the user of user device 102 may be enabled to interact with feedback interface 130 to indicate the “Deep” preference with respect to displayed content 126.

As described above, feedback interface 130 may be configured to enable the user to provide their feedback in any suitable form, including by one or more of mouse clicks, touch, motion, voice, etc. For instance, FIG. 4 shows an example graphical user interface (GUI) element 400 that enables a user to indicate various preferences with respect to displayed content, according to an embodiment. As shown in FIG. 4, GUI element 400 may be a list or a pop up menu that is present when a user interacts with displayed content 126 of FIG. 1. For instance, when the user hovers a mouse pointer over displayed content 126, touches displayed content 126 on display screen 110, makes a particular predetermined hand motion, speaks a predetermined one or more words, or interacts with displayed content 126 via feedback interface 130 in another way, GUI element 400 may be displayed adjacent to or over displayed content 126 in display screen 110. The user may then provide a subsequent action, such as a click, a touch, a motion, or a speaking of the appropriate word, to indicate their feedback of one of “No”, “More”, or “Deep” (or other suitable labels provided in GUI element 400). Note that GUI element 400 is shown for purposes of illustration, and in other embodiments may have other suitable forms, as would be apparent to persons skilled in the relevant art(s) based on the teachings herein (e.g., a radio button, a pull down menu, etc.).

As shown in FIG. 1, network interface 106 of user device 102 may transmit a content feedback signal 120 to server 104 that indicates the feedback provided by the user to displayed content 126 and received by action interpreter 108. Content feedback signal 120 may also include identifying information for displayed content 126. As shown in FIG. 1, network interface 112 of server 104 may receive content feedback signal 120. Content selector 114 at server 104 is configured to select next content to be displayed for displayed content 126 based on the feedback received in content feedback signal 120.

For instance, if content feedback signal 120 indicates that the user did not prefer displayed content 126 (e.g., “No”), content selector 114 may select content that is not related to displayed content 126 (e.g., a different category and/or topic of content). If content feedback signal 120 indicates that the user did prefer displayed content 126, and thus desires additional similar content (e.g., “More”), content selector 114 may select content that is related to displayed content 126 (e.g., categorized in a same category, and optionally in a same topic). If content feedback signal 120 indicates that the user did prefer displayed content 126, and thus desires content that is more descriptive of displayed content 126 (e.g., “Deep”), content selector 114 may select content that is closely related to displayed content 126 (e.g., categorized in a same category, and a same topic of content under the same category).

Content selector 114 may retrieve the selected next content from content storage 116 (e.g., one or more of first content 124a, second content 124b, third content 124c and/or other content stored in content storage 116), and provide the selected next content to network interface 112 to transmit to user device 102. As shown in FIG. 1, network interface 112 transmits a selected next content signal 122 from server 104 that includes the next content selected by content selector 114 in response to content feedback signal 120. Network interface 106 of user device 102 may receive selected next content signal 122. The selected next content received in selected next content signal 122 may be displayed in page 118 by display screen 110 for the user to view. In an embodiment, the selected next content may be displayed in page 118 in place of displayed content 126, in a same size and position in page 118 as displayed content 126 was displayed.

In this manner, a user of user device 102 is enabled to provide content-specific feedback on content that may be displayed in a screen/page side-by-side with other content. Furthermore, the feedback is more than a mere like/dislike type of content, but also indicates further types of content that the user may desire to be displayed (e.g., different content, similar content, content that is more descriptive, etc.). Still further, the content that is selected in response to the feedback may be displayed in place of the displayed content that the feedback was provided on. Thus, a portion of a displayed page/screen may be changed based on user feedback, while the rest of the page/screen does not change.

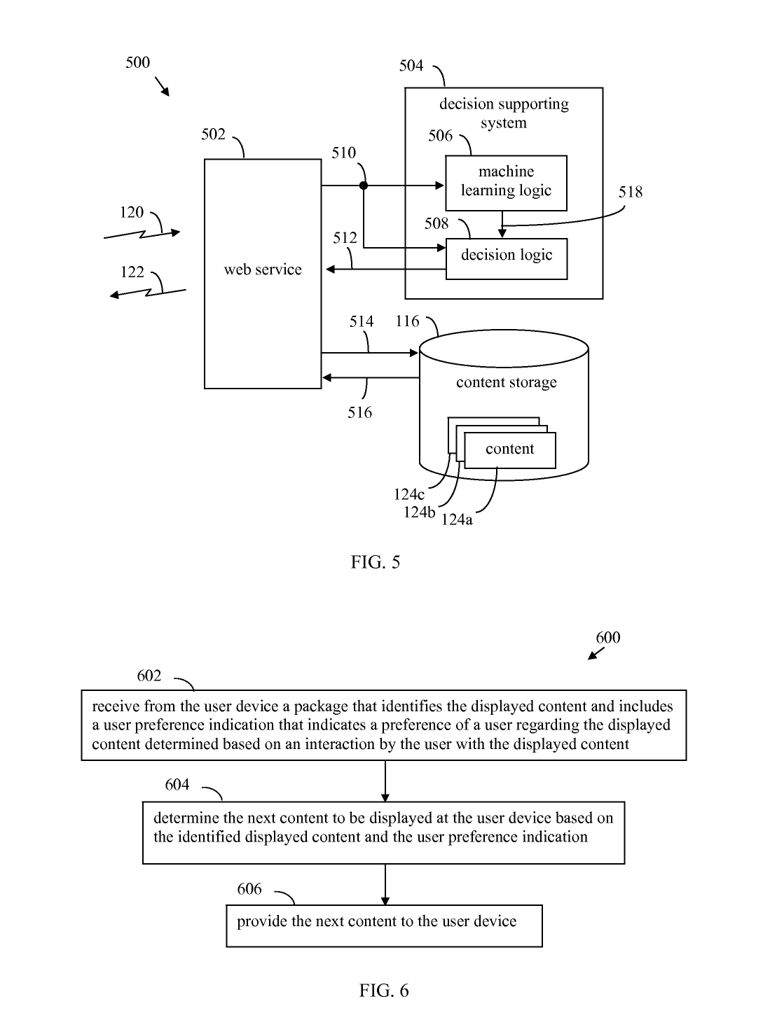

In embodiments, server 104 may be configured in various ways to perform its functions. FIG. 5 is a block diagram of a server 500 that is configured to receive a user-indicated preference regarding displayed content, and to select new content based thereon, according to an example embodiment. Server 500 is an example of server 104 shown in FIG. 1. As shown in FIG. 5, server 500 includes a web service 502, a decision supporting system 504, and content storage 116. Furthermore, decision supporting system 504 includes machine learning logic 506 and decision logic 508.

For ease of illustration, server 500 is described with reference to FIG. 6. FIG. 6 depicts a flowchart 600 of a method by which new content is selected and provided in response to a categorization of and feedback provided regarding displayed content, according to an example embodiment. In an embodiment, server 500 may operate according to flowchart 600. Flowchart 600 and server 500 are described as follows. Further structural and operational embodiments will be apparent to persons skilled in the relevant art(s) based on the following description.

Flowchart 600 begins with step 602. In step 602, a package is received from the user device that identifies the displayed content and includes a user preference indication that indicates a preference of a user regarding the displayed content determined based on an interaction by the user with the displayed content. For example, as shown in FIG. 5, web service 502 receives content feedback signal 120 from user device 102. Content feedback signal 120 may include a user data package that identifies displayed content 126, and indicates the feedback provided by the user to displayed content 126.

Displayed content 126 may be identified in the package in various ways, such as by one or more identifiers (e.g., numerical, alphanumerical, etc.) and/or other identifying information. For instance, in an embodiment, each content item may be classified in a topic of a category, where multiple categories may be present, and each category includes multiple topics. Thus, each content item, such as displayed content 126, first content 124a, second content 124b, third content 124c, etc., may be categorized by a category and topic. For example, in an embodiment, each content item may have an associated category identifier that indicates a category of the content item, may have an associated topic identifier that indicates a topic of the content item, and may have an associated content identifier that specifically (e.g., uniquely) identifies the content item itself.

Accordingly, content feedback signal 120 may include an indication of a first category identifier that indicates a category of displayed content 126, a first topic identifier that indicates a topic of displayed content 126, a first item identifier that identifies displayed content 126, and a user preference indication provided as the feedback provided by the user to displayed content 126.

Categories, topics, and content may be organized in a hierarchy in any manner, with categories at the top (broadest) and content at the bottom (most specific). Any number of different types of categories and topics may be present. Examples of categories may include news, consumer products, automobiles, technology, etc. Examples of topics under the news category may include entertainment, politics, sports, etc. Examples of topics under the consumer products category may include luxury, clothing, etc. Examples of topics under the automobiles category may include Ford, Lexus, Honda, sports cars, etc. Thus, a topic is categorized in the hierarchy as a subset of a category. Examples of content under the Ford topic may include the Focus automobile, the Fusion automobile, the Escape automobile (and/or further models of automobiles manufactured by Ford Motor Company). Thus, content is categorized in the hierarchy as an element of a topic.

Note that in other embodiments, a hierarchy may include more or fewer hierarchy levels than three as in the present example (e.g., category, topic, item). Thus, content items may be defined by more or fewer identifiers than the category identifier, topic identifier, and item identifier.

Note that the category identifier, topic identifier, and item identifier for a particular content item may be determined and assigned to the content item at any time. For instance, first content 124a, second content 124b, and third content 124c may each have a corresponding item identifier assigned to them and associated with them in content storage 116 (e.g., by web service 502 of FIG. 5 or by other entity), prior to their being transmitted for display by a user device. Such an item identifier may be stored in metadata of the content item, or may be otherwise associated with the content item.

Furthermore, first content 124a, second content 124b, and third content 124c may each have a corresponding category identifier and/or topic identifier assigned to them and associated with them in content storage 116 (e.g., automatically by web service 502 of FIG. 5, by a content developer, or by other entity), prior to their being transmitted for display by a user device. Alternatively, a category identifier and/or topic identifier may be assigned and associated with a content item after being transmitted to a user device, and thus may be assigned by the user device (e.g., by action interpreter 108 of FIG. 1 or by another entity).

For instance, page 118 may have an associated category identifier and topic identifier stored in code (e.g., HTML code, XML code, etc.) of page 118. For instance, the category identifier and topic identifier may be indicated as a tag, may be included in header information, or may be otherwise included in page 118. When particular content is displayed in page 118, such as displayed content 126, the particular content may have an assigned content identifier, and may take on the category and topic identifier of page 118.

In another embodiment, the particular content may be analyzed at server 104 (e.g., by web service 502) or at user device 102 (e.g., by action interpreter 108) to determine a category and topic in which the content belongs, and to thereby select the corresponding category identifier and topic identifier for the content. For instance, in one example, displayed content 126 may include text, such as one or more words, sentences, or paragraphs. The text may be parsed for one or more keywords using one or more keyword parsing techniques that will be known to persons skilled in the relevant art(s). The keywords may be applied to a first table that lists categories on one axis, and lists keywords on another axis. The category of the column (or row) that is determined by analysis of the first table to include the most keywords found in the parsed text may be selected as the category displayed content 126. Thus, the category identifier for the selected category may be associated with displayed content 126. Similarly, using a second table that lists topics on one axis, and lists keywords on another axis may be used to determine the topic, and thereby the topic identifier, for displayed content 126. In other embodiments, other types of data structures than tables may be used to determine category and topic identifiers for content, such as arrays, data maps, etc.

In another example, displayed content 126 may include one or more images (e.g., including a video, which is a stream of images). In a similar manner as described above, the image(s) can be analyzed for keywords and/or for objects (e.g., people, trees, clothing, automobiles, consumer products, luxury items, etc.), and the determined keywords and/or objects may be compared to one or more data structures to determine category and topic identifiers for displayed content 126.

Such determinations may be performed at user device 102 and/or server 104. The determined category identifier and topic identifier may be stored in metadata of the content item, or may be otherwise associated with the content item.

Referring back to FIG. 6, in step 604 of flowchart 600, the next content to be displayed at the user device is determined based on the identified displayed content and the user preference indication. Referring to FIG. 5, in an embodiment, decision logic 508 may be configured to determine next content for display at the user device based on the identified displayed content and the user preference indication.

For instance, as shown in FIG. 5, decision logic 508 receives a user data package 510 from web service 502. User data package 510 indicates the content on which feedback was provided (e.g., displayed content 126 of FIG. 1), and indicates the feedback. In an embodiment, user data package 510 may include the category identifier, the topic identifier, and the item identifier for displayed content 126 as the identifying information. Furthermore, user data package 510 may include an indication of “No”, “More”, or “Deep”, or other suitable feedback provided by the user by interacting with displayed content 126. Decision logic 508 may determine the next content for display, which may be retrieved from content storage 116, based on the identifiers and feedback. As shown in FIG. 5, decision logic 508 generates selected content indication 512, which indicates the determined next content.

For example, if an indication of “No” is received, decision logic 508 may select new content for display that is unrelated to displayed content 126. For instance, decision logic 508 may select new content from a different category than displayed content 126. If an indication of “More” is received, decision logic 508 may select new content for display that is related to displayed content 126. Decision logic 508 may select new content from a same category of content as displayed content 126, but from a same or different topic than displayed content 126. If an indication of “Deep” is received, decision logic 508 may select new content for display that is closely related to displayed content 126. For instance, decision logic 508 may select new content from a same category of content and a same topic as displayed content 126.

Referring back to FIG. 6, in step 606, the next content is provided to the user device. For instance, as shown in the example of FIG. 5, web service 502 receives selected content indication 512 from decision logic 508. Web service 502 is configured to retrieve the next content indicated in selected content indication 512 from content storage 116. Web service 502 may issue a content retrieval request 514 that identifies the next content. Content storage 116 receives content retrieval request 514, and in response thereto, accesses the next content in storage, and provides the next content to web service 502 as selected content 516. Web service 502 may transmit selected next content signal 122 from server 500, which includes the next content selected in response to content feedback signal 120. As described above, the user device (e.g., user device 102 of FIG. 1) receives selected next content signal 122 and displays the next content contained therein to the user.

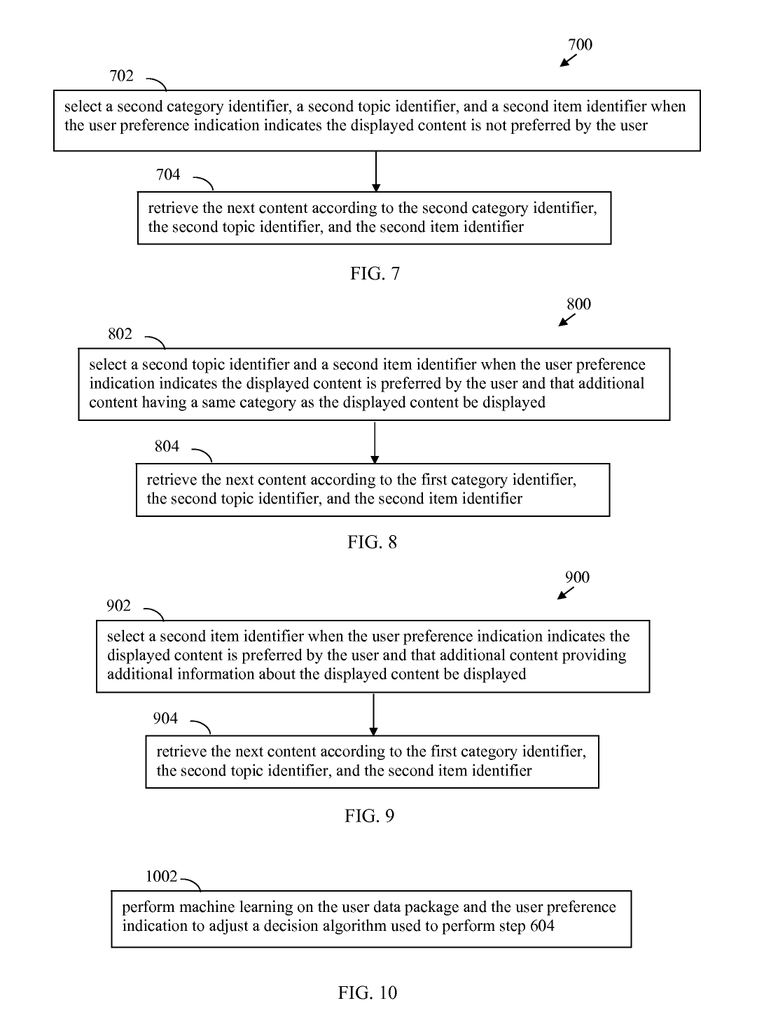

In embodiments, decision logic 508 may operate in various ways to perform step 604 of flowchart 600 (FIG. 6). In an example embodiment, decision logic 508 may operate according to FIGS. 7-9, which depict flowcharts of methods for selecting next content based on received content identifiers and user feedback. FIGS. 7-9 are described as follows.

For example, FIG. 7 depicts a flowchart 700 of a method by which a server retrieves new content based on a user indicating displayed content is not preferred, according to an embodiment. For instance, user data package 510 may include a user preference indication that indicates the user did not prefer displayed content 126 (e.g., a feedback of “No”). In such case, in step 702 of flowchart 700, a second category identifier, a second topic identifier, and a second item identifier are selected when the user preference indication indicates the displayed content is not preferred by the user. In an example, the category, topic, and item identifiers received in user data package 510 may be represented as (where “n” is an index):
CID(n)=Current category identifier
TID(n)=Current topic identifier
IID(n)=Current item identifier
   In the event that the user preference indication indicates that the user did not prefer displayed content 126, each identifier may be recalculated to a next value, as represented below:
CID(n+1)=Next(CID(n))
TID(n+1)=Next (TID(n))
IID(n+1)=Next ((IID(n)) where:

Next( )=a decision algorithm implemented by decision logic 508 to select next content.

In this manner, the next content may be identified by the new values for the category, topic, and item identifiers.

In step 704, the next content is retrieved according to the second category identifier, the second topic identifier, and the second item identifier. Continuing the example from step 702, in an embodiment, decision logic 508 may provide the new category, topic, and item identifiers to web service 502 in selected content indication 512, and web service 502 may retrieve the next content item identified by the new category, topic, and item identifiers from content storage 116.

FIG. 8 depicts a flowchart of a method by which a server retrieves new content based on a user indication that similar content to displayed content is desired, according to an example embodiment. For instance, user data package 510 may include a user preference indication that indicates the user did prefer displayed content 126 and wanted similar content (e.g., a feedback of “More”). In such case, in step 802 of flowchart 800, a second topic identifier and a second item identifier are selected when the user preference indication indicates the displayed content is preferred by the user and that additional content having a same category as the displayed content be displayed. In this example, the topic and item identifiers may be recalculated to next values, while the category identifier is not changed, as represented below:
CID(n+1)=CID(n)
TID(n+1)=Next (TID(n))
IID(n+1)=Next ((IID(n))
   In this manner, the next content may be identified by the new values for the topic and item identifiers, and the same, unchanged category identifier.

In step 804, the next content is retrieved according to the first category identifier, the second topic identifier, and the second item identifier. Continuing the example from step 802, in an embodiment, decision logic 508 may provide the unchanged category identifier and the new topic and item identifiers to web service 502 in selected content indication 512, and web service 502 may retrieve the next content item identified by these identifiers from content storage 116.

FIG. 9 depicts a flowchart of a method by which a server retrieves new content based on a user indication that content providing additional information for displayed content is desired, according to an example embodiment. For instance, user data package 510 may include a user preference indication that indicates the user did prefer displayed content 126 and wanted content more descriptive of the displayed content (e.g., a feedback of “Deep”). In such case, in step 902 of flowchart 900, a second item identifier is selected when the user preference indication indicates the displayed content is preferred by the user and that additional content providing additional information about the displayed content be displayed. In this example, the index for the item identifier may be recalculated to a next value, while the category and topic identifiers are not changed, as represented below:
CID(n+1)=CID(n)
TID(n+1)=TID(n)
IID(n+1)=Next ((IID(n))
   In this manner, the next content may be identified by the new value for the item identifier, and the same, unchanged category and topic identifiers.

In step 904, the next content is retrieved according to the first category identifier, the second topic identifier, and the second item identifier. Continuing the example from step 902, in an embodiment, decision logic 508 may provide the unchanged category and topic identifiers and the new item identifier to web service 502 in selected content indication 512, and web service 502 may retrieve the next content item identified by these identifiers from content storage 116.

Note that in an embodiment, machine learning and/or other learning techniques may be performed to improve decisions made by decision logic 508. For instance, as shown in FIG. 5, machine learning logic 506 may receive user data package 510. Machine learning logic 506 may use the contents of user data package 510 to improve a decision algorithm used by decision logic 506 to select next content. For instance, machine learning logic 506 may use machine learning to gradually adjust the decision algorithm to be more precise.

Machine learning logic 506 may operate according to FIG. 10. FIG. 10 depicts a step 1002 of a method for performing machine learning on user feedback provided on displayed content, according to an example embodiment. In step 1002, machine learning is performed on the user data package and the user preference indication to adjust a decision algorithm used to perform step 604.

As shown in FIG. 5, machine learning logic 506 may output a modified decision algorithm 518, which is received by decision logic 508. Modified decision algorithm 518 may be used to perform future determinations of next content.

B. Example Content Feedback Interface Embodiments

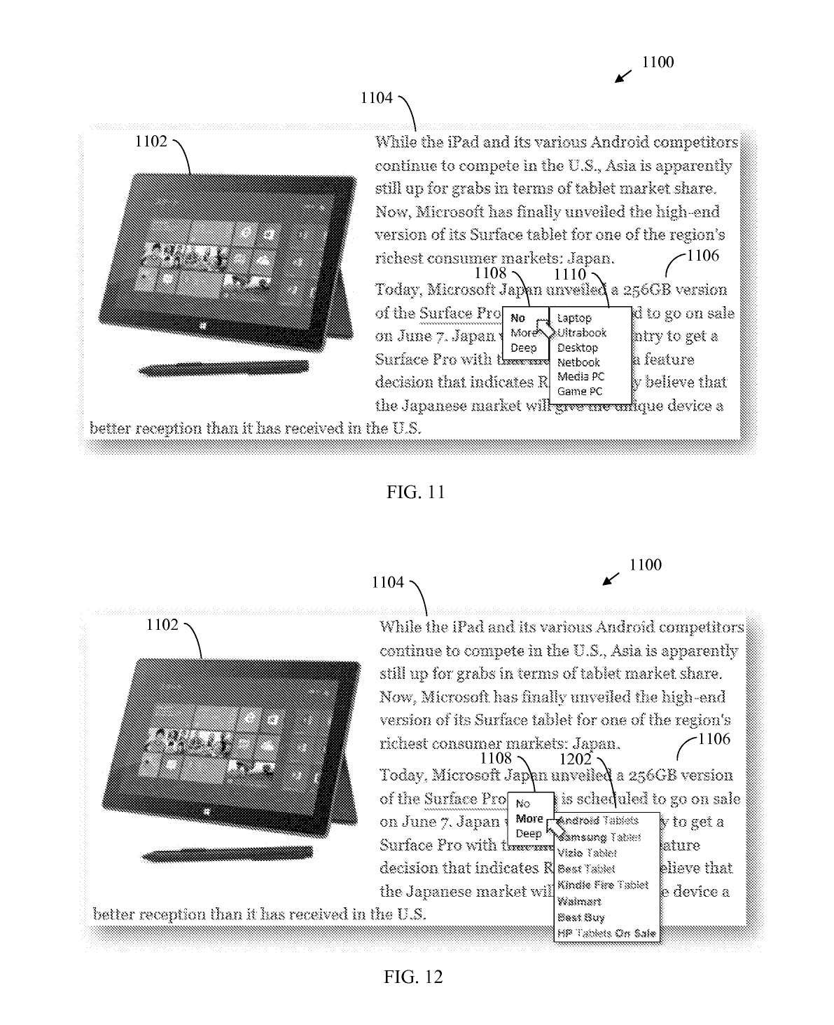

As described above, users are enabled to provide feedback directly on displayed content to cause additional content to be selected and displayed. Example techniques for providing feedback on displayed content to cause additional content to be selected and displayed are described as follows. For instance, FIGS. 11-24 show examples of displayed content, of interactions by users with the displayed content to provide feedback, and of newly displayed content selected based on the feedback, according to embodiments. FIGS. 11-24 are shown for exemplary purposes only, and are not intended to be limiting. Content may be displayed, and feedback may be provided thereon by users, in any suitable manner, as would be apparent to persons skilled in the relevant art(s) from the teachings herein. FIGS. 11-24 are described as follows.

In one set of examples, FIGS. 11-17 each show a page 1100 in which an image 1102 of a tablet computer is shown on a left side, and first and second paragraphs 1104 and 1106 of text are shown on a right side. In FIG. 11, a user interacts with an interface device (e.g., a touch pad, a mouse, etc.) to move a pointer over the text/keywords “Surface Pro” in second paragraph 1106 to interact with the keywords. For example, the user may perform a click using the interface device to cause a pop up menu 1108 to be presented over page 1100 with respect to the keywords. Pop up menu 1108 is similar to GUI element 400 of FIG. 4, and enables a user to indicate their feedback of one of “No”, “More”, or “Deep” with respect to the keywords “Surface Pro.” For instance, as shown in FIG. 11, if the user selects (e.g., clicks on, hovers over, or otherwise interacts with) the option of “No” in pop up menu 1108, indicating they do not prefer the content of “Surface Pro,” a second pop up menu 1110 (or other UI element) may be presented that enables the user to select alternative content to “Surface Pro” for display. In this example, “Surface Pro” may be categorized under the category of computers, and sub-category/topic of tablet computers. Thus decision logic 508 (FIG. 5) may select keywords for display that are under the category of computers, but related to other topics than tablets. In the example of FIG. 11, decision logic 508 may select keywords such as “Laptop”, “Ultrabook”, “Desktop”, etc., for display, which may each be selected by the user to cause additional content to be displayed.

In FIG. 12, alternatively to selecting “No”, the user may select the option of “More” in pop up menu 1108, indicating they do prefer the content of “Surface Pro,” and want to see similar keywords. As such, a third pop up menu 1202 may be presented that enables the user to select related content to “Surface Pro” for display. In this example, decision logic 508 may select keywords for display that are under the category of computers, and included in the topic of tablet computers. For instance, decision logic 508 may select keywords such as “Android Tablets”, “Samsung Tablet”, etc., for display, which may each be selected by the user to cause additional content to be displayed.

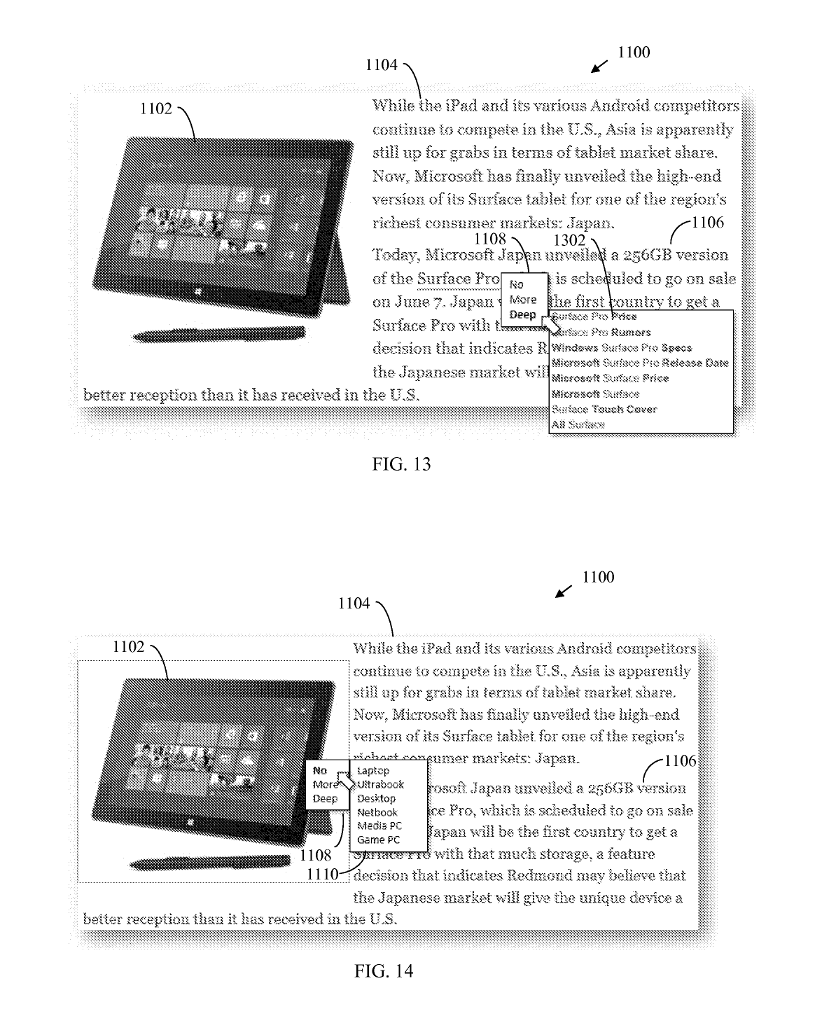

In FIG. 13, the user may instead select the option of “Deep” in pop up menu 1108, indicating they do prefer the content of “Surface Pro,” and want to see more descriptive keywords regarding “Surface Pro”. As such, a fourth pop up menu 1302 may be presented that enables the user to select more descriptive content to “Surface Pro” for display. In this example, decision logic 508 may select keywords for display that are under the category of computers, and topic of tablet computers, and more descriptive of “Surface Pro.” For instance, decision logic 508 may select keywords such as “Surface Pro Price”, “Surface Pro Rumors”, etc., for display, which may each be selected by the user to cause additional content to be displayed.

In the example of FIGS. 14-16, the user interacts with image 1102 to provide feedback by moving a pointer over image 1102. The user may perform a click using the interface device to cause pop up menu 1108 to be presented over page 1100 with respect to image 1102. In FIG. 14, the user selects the option of “No” in pop up menu 1108, indicating they do not prefer the content of image 1102. As such, second pop up menu 1110 may be presented that enables the user to select alternative content to image 1102 for display. In this example, image 1102 shows a Microsoft® Surface Pro™ computing device, and thus image 1102 may be categorized under the category of computers, and under the sub-category/topic of tablet computers. Thus decision logic 508 (FIG. 5) may select other computers for listing in pop up menu 1110 that are under the category of computers, but related to other topics than tablets. In the example of FIG. 14, decision logic 508 may select “Laptop”, “Ultrabook”, “Desktop”, etc., for display, which may each be selected by the user to cause additional content to be displayed.

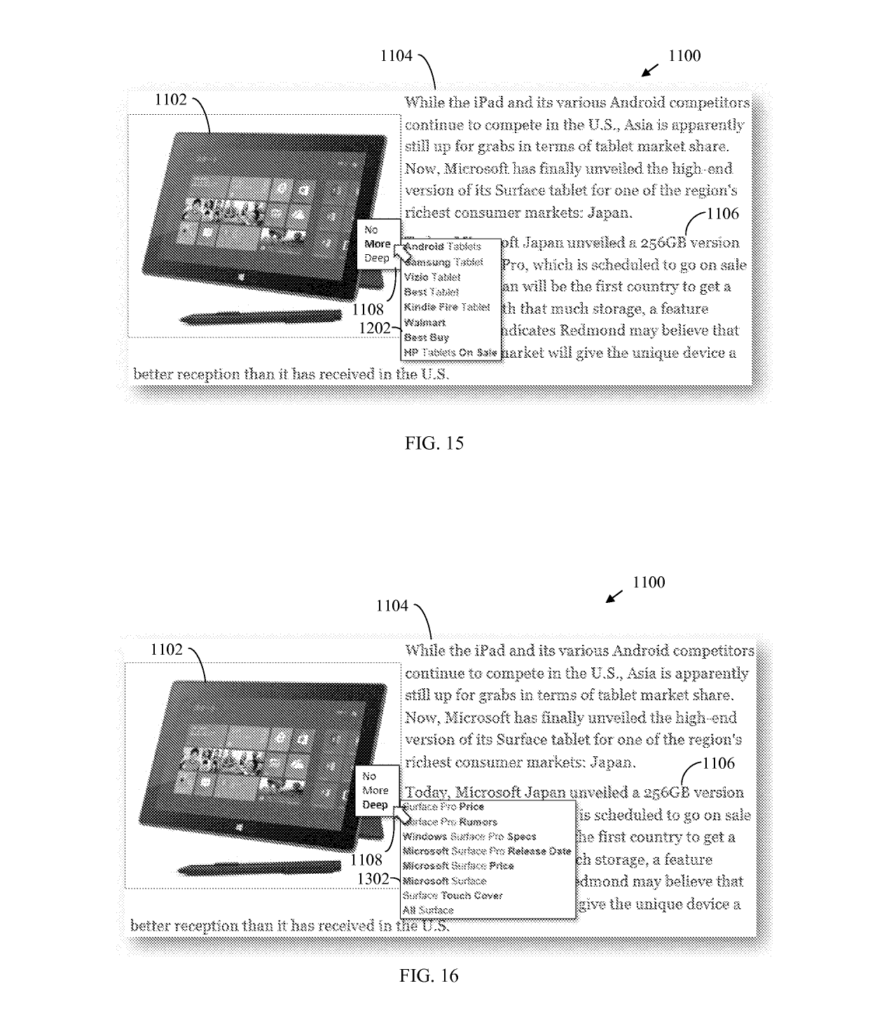

In FIG. 15, the user may instead select the option of “More” in pop up menu 1108, indicating they do prefer image 1102, and want to see similar content. As such, third pop up menu 1202 may be presented that enables the user to select related content to image 1102 for display. In this example, decision logic 508 may select images or other content for display that are under the category of computers, and included in the topic of tablet computers. For instance, decision logic 508 may list names of content such as “Android Tablets”, “Samsung Tablet”, etc., for display, which may each be selected by the user to cause additional content to be displayed.

In FIG. 16, the user may instead select the option of “Deep” in pop up menu 1108, indicating they do prefer image 1102 and want to see more descriptive content regarding image 110. As such, fourth pop up menu 1302 may be presented that enables the user to select content that is more descriptive of image 1102 for display. In this example, decision logic 508 may select images or other content for display that are under the category of computers, and topic of tablet computers, and more descriptive of image 1102. For instance, decision logic 508 may select content having names such as “Surface Pro Price”, “Surface Pro Rumors”, etc., for display, which may each be selected by the user to cause additional content to be displayed.

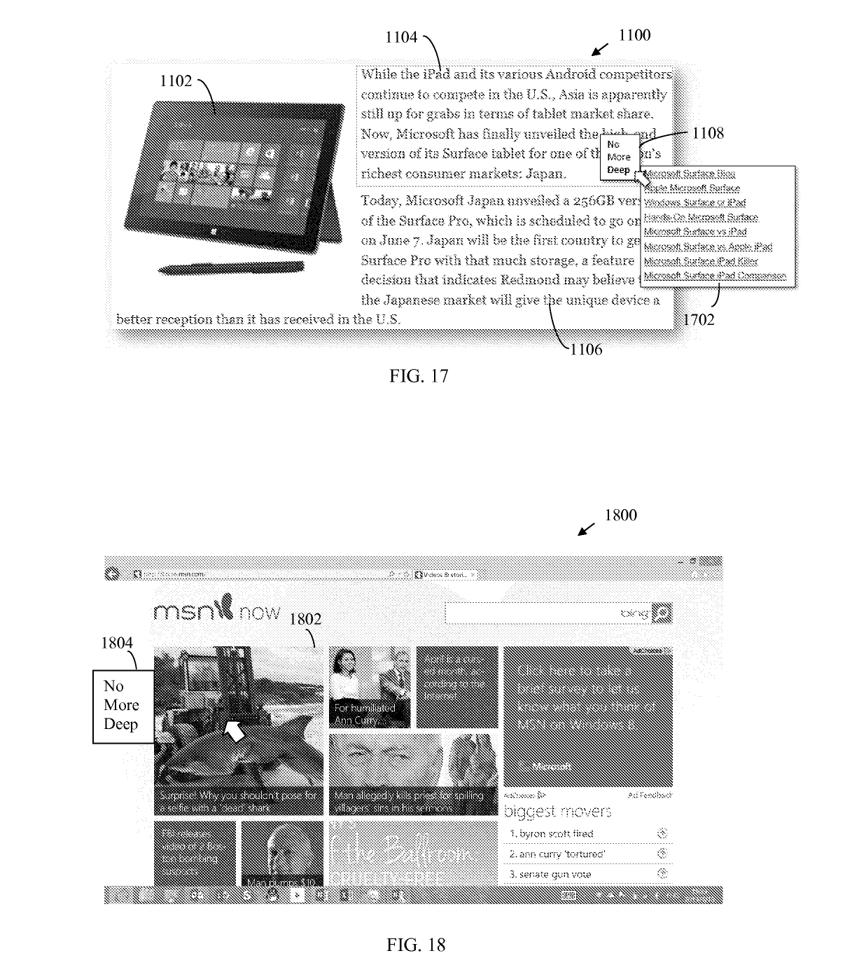

In FIG. 17, the user interacts with first paragraph 1104 to provide feedback by moving a pointer over first paragraph 1104. The user may perform a click using the interface device to cause pop up menu 1108 to be presented over page 1100 with respect to first paragraph 1104. In FIG. 14, the user selects the option of “Deep” in pop up menu 1108, indicating they do prefer first paragraph 1104 and want to see more descriptive content regarding first paragraph 1104. As such, a fifth pop up menu 1702 may be presented that enables the user to select content that is more descriptive of first paragraph 1104 for display. In this example, web service 502, decision logic 508, action interpreter 108, or other entity may analyze text of first paragraph 1104, such as by parsing the text as described above, to determine a category and topic of first paragraph 1104. For instance, computers may be determined as a category of first paragraph 1104, and Microsoft® Surface™ may be determined as the topic of first paragraph 1104. As such, decision logic 508 may select images or other content for display that are under the category of computers, and topic of Microsoft® Surface™, and are more descriptive of first paragraph 1104. For instance, decision logic 508 may select content having names such as “Microsoft Surface Blog”, “Apple Microsoft Surface”, etc., for display, which may each be selected by the user to cause additional content to be displayed.

In a similar manner as described above, the “No” and “More” options may be selected in pop up menu 1108 in FIG. 17 to cause additional content to be selected for display.

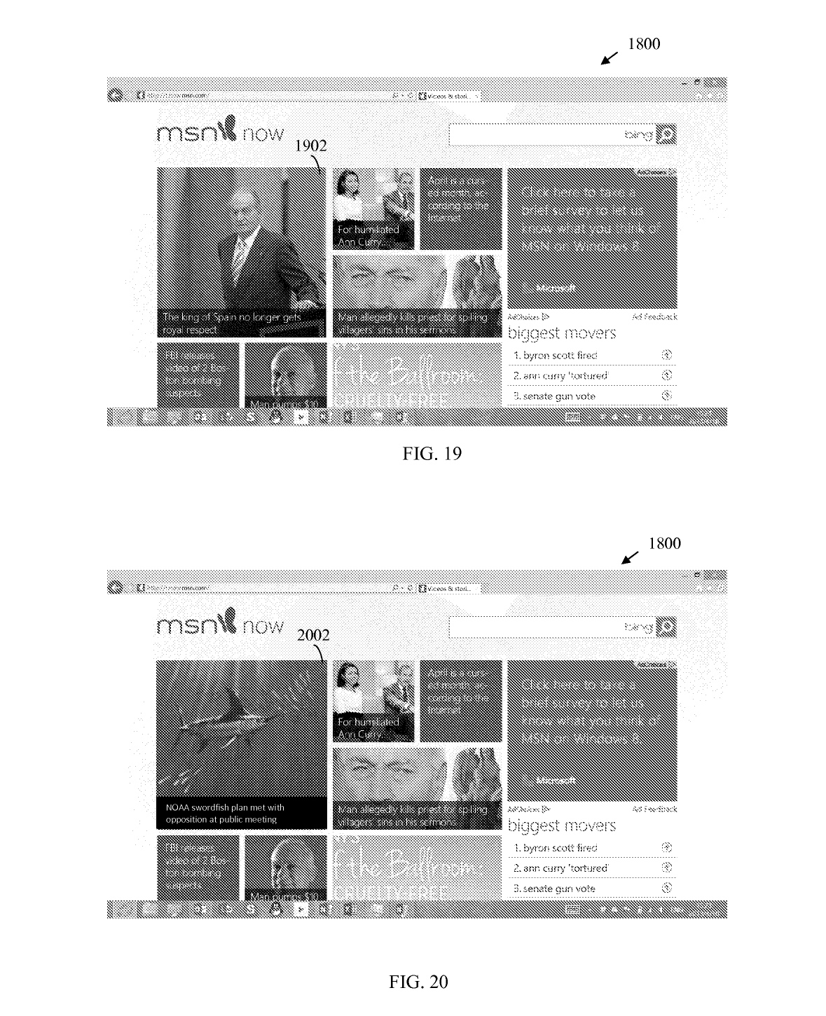

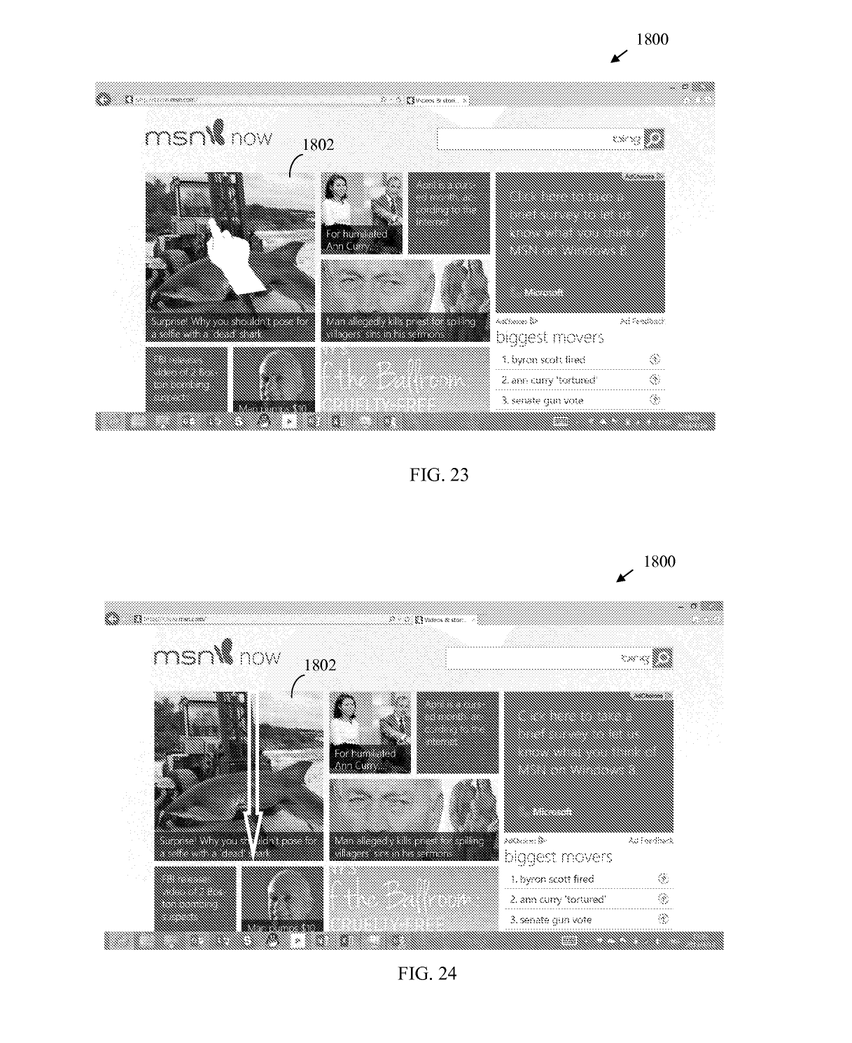

In another set of examples, FIGS. 18-24 each show a page 1800 in which various forms of content are present, including text and images. A first image 1802 is present in an upper left corner of page 1800 that shows a picture of a shark and includes a textual caption of “Surprise! Why you shouldn't pose for a selfie with a ‘dead’ shark.” FIGS. 18-24 show examples of interactions with image 1802 to provide feedback, and examples of next content selected based on the feedback. FIGS. 18-22 relate to non-touch embodiments for providing feedback, FIGS. 23 and 24 relate to touch embodiments for providing feedback.

In FIG. 18, a user interacts with an interface device (e.g., a touch pad, a mouse, etc.) to move a pointer over image 1802 to provide feedback on image 1802. For example, the user may perform a click using the interface device to cause a pop up menu 1804 to be presented over page 1800 with respect to image 1802. Pop up menu 1804 is similar to GUI element 400 of FIG. 4, and enables a user to indicate their feedback of one of “No”, “More”, or “Deep” with respect to image 1802. For instance, as shown in FIG. 18, if the user selects the option of “No” in pop up menu 1804, indicating they do not prefer the content of “image 1802, replacement content for image 1802 may be automatically selected and displayed in place of image 1802. In this example, image 1802 may be categorized under the category of news, with a sub-category/topic of sea life. Thus decision logic 508 (FIG. 5) may select content for display that is under the category of news, but related to other topics than sea life. For instance, FIG. 19 shows page 1800 with an image 1902 displayed in place of image 1802. Image 1902 is displayed in the same position in page 1800 as was image 1802, and has a same size as image 1802. However, image 1902 is categorized under the category of news and topic of international (showing the king of Spain), and thus relates to a different topic than image 1802.

Alternatively in FIG. 18, the user may select the option of “More” in pop up menu 1802, indicating they do prefer image 1802, and want to see similar content. As such, similar content to image 1802 may be automatically selected and displayed in place of image 1802. Thus, decision logic 508 (FIG. 5) may select content for display that is categorized under the category of news and the topic of sea life. For instance, FIG. 20 shows page 2000 with an image 2002 displayed in place of image 1802. Image 2002 is displayed in the same position in page 1800 as was image 1802, and has a same size as image 1802. Image 2002 is categorized under the category of news and the topic of sea life (showing a swordfish), and thus relates to a same topic as image 1802.

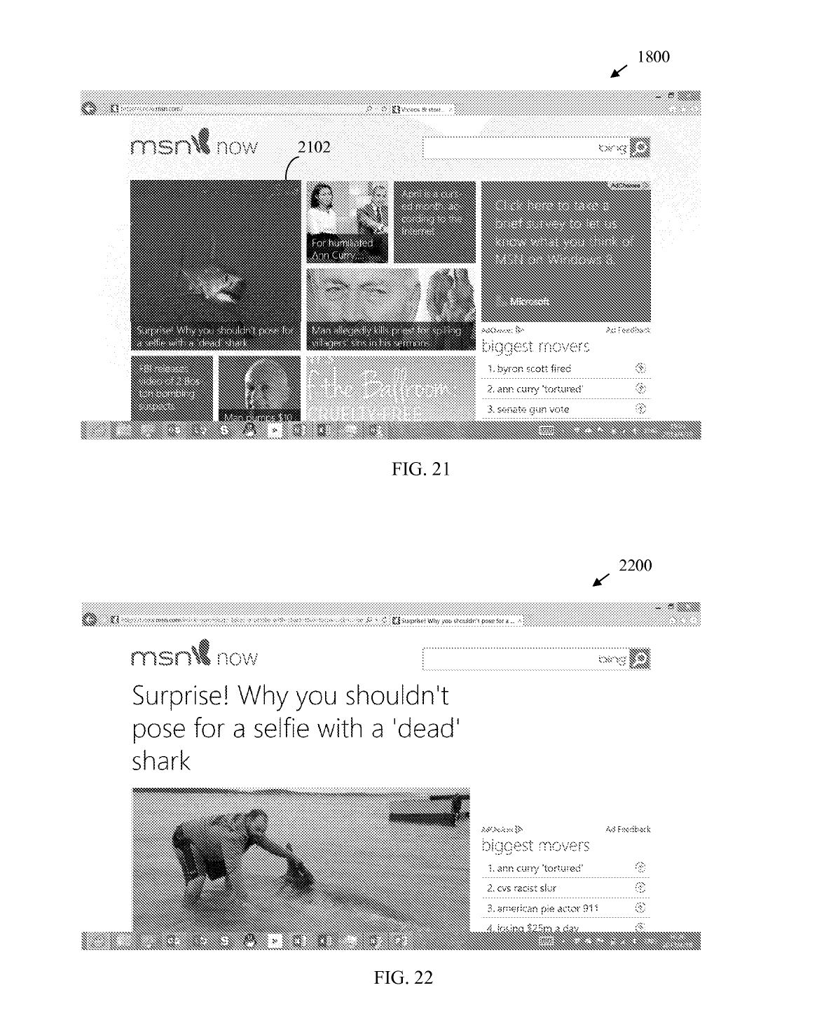

In another case, the user may select the option of “Deep” in pop up menu 1802, indicating they do prefer image 1802, and want to see more descriptive content. As such, content more descriptive of image 1802 may be automatically selected and displayed in place of image 1802. Thus, decision logic 508 (FIG. 5) may select content for display that is categorized under the category of news and the topic of sea life, and is descriptive of the content of image 1802 (e.g., sharks). For instance, FIG. 21 shows page 2100 with an image 2102 displayed in place of image 1802. Image 2102 is displayed in the same position in page 1800 as was image 1802, and has a same size as image 1802. Image 2102 is categorized under the category of news and the topic of sea life, showing a shark, and thus shows content that is descriptive of the content of image 1802.

It is noted that in an alternative embodiment, rather than displaying selected content in place of displayed content, the selected content may be displayed in another location, including a page that is different from the page of the displayed content. For instance, when the user selects the option of “Deep” in pop up menu 1802 in FIG. 18, a new page 2200 shown in FIG. 22 may be displayed that shows selected content categorized under the category of news and the topic of sea life, and that is descriptive of the content of image 1802. Page 2200 shows an image and text that relates to a person posing for a picture with a shark, and thus shows content that is descriptive of the content of image 1802.

Furthermore, it is noted that the interactions with image 1802 with or without pop up menu 1804 may be performed using touch, motion sensing, speech recognition, or other feedback interface techniques. For instance, FIG. 23 shows a user that touches a display screen at a location of image 1802 in page 1800 to provide feedback on image 1802, as represented by a transparent hand in FIG. 23. The user may touch the screen in any manner, according to any pattern, to convey a selection of “No,” “More,” or “Deep” with respect to image 1802. For instance, the user may touch an upper portion of image 1802 in page 1800 to indicate “No,” may touch a left side portion of image 1802 in page 1800 to indicate “More,” or may touch a central portion of image 1802 in page 1800 to indicate “Deep.” In touch embodiments, any combination of touching, including finger touches/taps, dragging/swiping of fingers, double tapping or additional taps, etc., may be used to indicate selections by the user.

For instance, FIG. 24 shows an example of a finger being dragged downward on page 1800 over content 1802 to indicate “No”. Similarly, a rightward drag of a finger over content 1802 may indicate “More”, and a tap on content 1802 may indicate “Deep.”

Thus, user feedback on content may be provided in various ways, and using any combinations of feedback techniques, including combinations of touch, non-touch, motion sensing of gestures, voice, etc.

In a non-touch example, “No” and “More” may be represented by displaying clickable buttons when a pointer is hovered over content, and “Deep” may be represented by a mouse click on the content.

In a touch example, “No” may be represented by a swipe up/down, “More” may be represented by a swipe left/right, and “Deep” may be represented by tapping on the content.

In motion example (e.g., using a Microsoft® Kinect™ device), “No” may be represented by waving your hand(s) up/down, “More” may be represented by waving your hand(s) left/right, and “Deep” may be represented by holding your hand(s) in a fist.

In a gesture example (e.g., using a Microsoft® Kinect™ device), “No” may be represented by a user shaking their head, “More” may be represented by the user nodding their head, and “Deep” may be represented by the user smiling.

In a voice example, “No” may be represented by a user saying “No,” “More” may be represented by the user saying “More,” and “Deep” may be represented by the user saying “Deep.”

In a combination interaction example, “No” may be represented by a user shaking their head (gesture), “More” may be represented by the user saying “More” (voice), and “Deep” may be represented by the user tapping on the displayed content (touch).

Note that these examples are provided for purposes of illustration, and are not intended to be limiting. It will be apparent to persons skilled in the relevant art(s) based on the teachings herein that any way of providing feedback, and combinations thereof, may be used.

### III. Example Incentive System

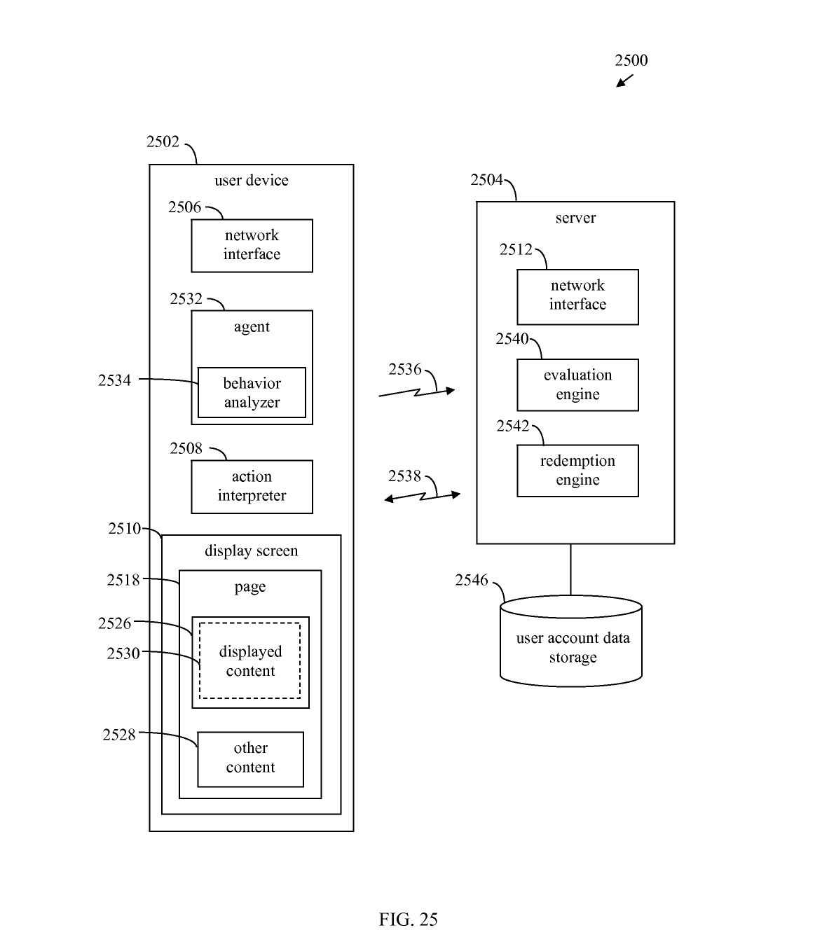

Embodiments of a system that incentives users to provide feedback about, consume, and/or interact with content will now be described. Such an incentive system may be implemented in devices and servers in various ways. For instance, FIG. 25 is a block diagram of an incentive system 2500 according to an example embodiment. In system 2500, information concerning feedback provided by a user with respect to content displayed on a user device 2502 is transmitted to a server 2504 where it is used to determine the value of an incentive that is then awarded to the user. As shown in FIG. 25, user device 2502 includes a network interface 2506, an action interpreter 2508, and a display screen 2510. Server 2504 includes a network interface 2512, an evaluation engine 2540, and a redemption engine 2542. Server 2504 includes or is coupled to user account data storage 2546.

User device 2502 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a RIM Blackberry® device, etc.), a wearable computing device (e.g., a smart watch, smart glasses such as Google® Glass™, etc.), or other type of mobile device (e.g., an automobile), or a stationary computing device such as a desktop computer or PC (personal computer). Server 2504 may be implemented in one or more computer systems (e.g., servers), and may be mobile (e.g., handheld) or stationary. Server 2504 may be considered a “cloud-based” server, may be included in a private or other network, or may be considered network accessible in another way.

User account data storage 2546 may include one or more of any type of storage mechanism to store user account data in the form of files or other form, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Network interface 2512 of server 2504 enables server 2504 to communicate over one or more networks, and network interface 2506 of user device 2502 enables user device 2502 to communicate over one or more networks. Examples of such networks include a local area network (LAN), a wide area network (WAN), a personal area network (PAN), or a combination of communication networks, such as the Internet. Network interfaces 2506 and 2512 may each include one or more of any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc.

Display screen 2510 of user device 2502 may be any type of display screen, such as an LCD (liquid crystal display) screen, an LED (light emitting diode) screen such as an organic LED screen, a plasma display screen, or other type of display screen. Display screen 2510 may be integrated in a single housing of user device 2502, or may be a standalone display. As shown in FIG. 25, display screen 2510 may be used to display content at user device 2502. For instance, a user of user device 2502 may interact with a user interface of user device 2502 to browse content, and cause content to be displayed by display screen 2510. For instance, content may be displayed by display screen 2510 that is contained in a page 2518, such as a web page rendered by a web browser, or content may be displayed in another form by another application.

As shown in FIG. 25, display screen 2510 may display displayed content 2526 and other content 2528. Displayed content 2526 and other content 2528 may each include one or more content items in the form of textual content or image content. In the example of FIG. 25, displayed content 2526 is configured to be able to be interacted with by a user of user device 2502 to provide feedback on displayed content 2526, according to an embodiment. For example, as shown in FIG. 25, displayed content 2526 may include a feedback interface 2530 that enables a user to provide feedback on displayed content 2526, such as by mouse clicks (e.g., on a displayed pop up menu, one or more virtual buttons, etc.), by touching display screen 2510, by motion sensing, by speech recognition, and/or by other user interface interaction. Other content 2528 may optionally be present, and may also be configured to be interacted with by a user to provide feedback thereon, or may not be configured to provide feedback.

Action interpreter 2508 is configured to interpret the feedback of the user provided with respect to displayed content 2526 using feedback interface 2530. For example, as described elsewhere herein, the user may provide feedback with respect to displayed content 2526 in the form of not preferring displayed content 2526 (e.g., not wanting to view displayed content 2526, but wanting to display alternative content instead), referred to herein as a feedback selection of “No”; preferring displayed content 2526 and wanting to view additional similar content, referred to herein as a feedback selection of “More”; and preferring displayed content 2526 and wanting to view additional content that is more descriptive of displayed content 2526 and/or conduct a transaction with respect to displayed content 2526, referred to herein as a feedback selection of “Deep”. Action interpreter 2508 is configured to receive the feedback provided to feedback interface 2530 by the user, and provide the feedback to network interface 2506 to be transmitted to server 2504.

User device 2502 may operate in accordance with the previously-described method of flowchart 200 to enable a user to provide feedback directly on displayed content at user device 2502, according to an example embodiment. Furthermore, a user can interact with user device 2502 in accordance with the previously-described method of flowchart 300 to indicate various preferences with respect to displayed content. Thus, a user is enabled to interact with the displayed content to indicate a first preference that the displayed content is not preferred and be replaced with a display of a replacement content, to interact with the displayed content to indicate a second preference that the displayed content is preferred and that additional content regarding a same topic as the displayed content be displayed, and to interact with the displayed content to indicate a third preference that the displayed content is preferred and that additional content providing additional information about the displayed content be displayed.

Feedback interface 2530 may be configured to enable the user to provide their feedback in any suitable form, including by one or more of mouse clicks, touch, motion, voice, etc. For instance, previously-described GUI element 400 may be used to enable a user to indicate various preferences with respect to displayed content, according to an embodiment. Furthermore, a user may provide feedback via any of the feedback mechanisms described above in relation to FIGS. 11-24 or using different mechanisms. Feedback may be provided explicitly in the sense that the user aware that he/she is providing feedback (e.g., by actively selecting one of “No,” “More,” or “Deep”) or may be provided implicitly in the sense that the user is not aware that his/her actions constitute a form of feedback (e.g., a user interaction with a display ad for the purpose of purchasing something may be interpreted as “Deep”).

In an embodiment, network interface 2506 of user device 2502 may transmit to a server a content feedback signal that indicates the feedback provided by the user with respect to displayed content 2526 and received by action interpreter 2508. The server may use such content feedback signal to select next content to be displayed for displayed content 2526 based on the feedback received in the content feedback signal. The server that performs this function may be a server such as server 104 as described above in reference to FIG. 1 or server 500 as described above in reference to FIG. 5. Such server may operate in a manner described above in reference to those embodiments to select next content to be displayed for displayed content 2526 based on the feedback received in the content feedback signal. Alternatively, server 2504 may itself include similar components to those included in server 104 or server 500 and thus perform like operations to select next content to be displayed for displayed content 2526 based on the feedback received in the content feedback signal.

In this manner, a user of user device 2502 is enabled to provide content-specific feedback on content that may be displayed in a screen/page side-by-side with other content. Furthermore, the feedback may be more than a mere like/dislike type of content, but can also indicate further types of content that the user may desire to be displayed (e.g., different content, similar content, content that is more descriptive, etc.). Still further, the content that is selected in response to the feedback may be displayed in place of the displayed content that the feedback was provided on. Thus, a portion of a displayed page/screen may be changed based on user feedback, while the rest of the page/screen does not change.

As further shown in FIG. 25, user device 2502 includes an agent 2532. Agent 2532 comprises logic that exists or is installed upon user device 2502 to enable a user of user device 2502 to participate in an incentive program that incentivizes the user to provide feedback about, consume, and/or interact with displayed content, such as displayed content 2526 or other content 2528. In an embodiment in which agent 2532 comprises a computer program, agent 2532 may be installed on user device 2502 in a variety of ways. For example, agent 2532 may be installed during manufacturing of user device 2502. Alternatively, agent 2532 may be installed after manufacturing of user device 2502 by downloading software from a remote entity (e.g., server 2504) via a network. Such downloading and installation may occur, for example, when a user first signs up for the incentive program. Still other methods may be used to install agent 2532 on user device 2502. Agent 2532 may comprise, for example and without limitation, a stand-alone application, a plug-in or part of some other program or application (e.g., a part or plug-in of a Web browser), or a part of an operating system 2502 of user device.

Agent 2532 operates to monitor and track feedback provided by the user of user device 2502 with respect to different items of content (e.g., displayed content 2526 and other content 2528). To this end, agent 2532 may receive information from action interpreter 2508 concerning the feedback provided by the user of user device 2502 with respect to different items of content. A behavior analyzer 2534 within agent 2532 may then analyze this information to generate measures that are transmitted to server 2504 via network interface 2506. In an embodiment, agent 2532 comprises a background process that executes in a transparent manner as the user is browsing content and providing feedback about such content. Such a background process may be launched, for example, as part of a start-up process that occurs when user device 2502 is powered on or when a particular application or process (e.g. a Web browser) is launched. However, this example is not intended to be limiting, and agent 2532 need not be implemented as a background process.

In one embodiment, behavior analyzer 2534 determines how many instances of each of a set of predefined feedback types the user has provided with respect to various items of content over a certain time period. The time period may, be for example, the time during which the user is involved in a browsing session or some other suitable timespan. For example, with respect to the previously-described model UI, behavior analyzer 2534 may determine how many instances of each of the following types of feedback the user has provided with respect to various items of content over a certain time period: (a) the number of “No” instances, each of which may indicate that the user dislikes a particular category of content, a particular brand, and/or a particular content item; (b) the number of “More” instances, each of which may indicate that the user likes a particular category of content, a particular brand, and/or a particular content item and wishes to see additional content dealing with similar subject matter (e.g., the same brand or the same category and/or topic of content); and (c) the number of “Deep” instances, each of which may indicate that the user wants to see additional information about a particular content item or wants to conduct a transaction with respect to the particular content item.

Agent 2532 transmits the measures generated by behavior analyzer 2534 via network interface 2506 as part of a feedback measures signal 2536. Server 2504 receives feedback measures signal 2536 via network interface 2512. Server 2504 includes an evaluation engine 2540 that utilizes the measures included in feedback measures signal 2536 to determine one or more incentives that will be awarded to the user as part of the incentive program. Evaluation engine 2540 then awards the incentives to the user by assigning the incentives to a user account associated with the user. This may be carried out by storing information about the incentives to be awarded to the user in association with the user account. Such information may be stored, for example, in user account data storage 2546.

Any of a wide variety of incentives may be awarded to the user, including both tangible and intangible incentives. For example and without limitation, the incentives may include money, goods, services, redeemable vouchers for goods or services, coupons for discounts on goods and services, honors, titles, enhanced program participation benefits, or the like. In one embodiment, the incentives comprise credits that can subsequently be redeemed by the user to obtain one or more tangible or intangible items of value.

Server 2504 also includes a redemption engine 2542. Redemption engine 2542 is configured to enable a user to identify and redeem the incentives that have been awarded to him/her by evaluation engine 2540. To this end, redemption engine 2542 has access to user account data for the user that includes an indication of any incentives that have been awarded to the user. As previously noted, such user account data may be stored in user account data storage 2546.

In an embodiment, redemption engine 2542 can be accessed by the user via a user interface of user device 2502 (or other device accessible to the user) that enables the user to interact with redemption engine 2542 to obtain access to his/her incentives. Such interaction is denoted by the bi-directional arrow marked with reference numeral 2538 in FIG. 25. In an embodiment in which the incentives comprise credits, the user can interact with redemption engine 2542 to determine how many credits he/she has accumulated and to redeem such credits for one or more items of value.

In a scenario in which an incentive is to be sent to the user, the user can interact with redemption engine 2542 to select a suitable channel for delivery. If the incentive comprises physical goods, selecting a suitable channel may include, for example, providing shipping instructions. If the incentive comprises a voucher or coupon, selecting a suitable channel may comprise selecting to receive the incentive in paper or electronic form. If an incentive is to be received in electronic form, selecting a suitable channel may comprise selecting to receive the incentive via a browser (e.g., as part of a Web page) or other Web-enabled application, via e-mail, via an SMS message, or the like.

In one embodiment, redemption engine 2542 is configured to serve one or more Web pages to a browser or other program running on user device 2502 (or other device accessible to the user) via which the user can interact with redemption engine 2542 to identify and/or redeem his/her incentives. In an alternate embodiment, an application or other computer program may be installed on user device 2502 (or other device accessible to the user) that, when executed, enables the user to interact with redemption engine 2542 to identify and/or redeem his/her incentives. Still other mechanisms may be used for facilitating interaction between the user and redemption engine 2542.

In an embodiment, evaluation engine 2540 determines the value of an incentive to be awarded to the user based on a type or types of feedback provided by the user with respect to content. That is to say, the value of the incentive that will be awarded to a user will vary based on the type or types of feedback that the user has provided with respect to content. For this to occur, the feedback provided by the user with respect to content must be classifiable into one of a plurality of predefined feedback types. An example of such a classification was provided above with respect to the model UI of Section II—namely, a “No” feedback type, a “More” feedback type, and a “Deep” feedback type. However, this is only one example, and user feedback about content may be classified into a wide variety of other arbitrarily-defined types (e.g., “like” and “dislike”; “highly interested,” “mildly interested” and “not interested”; a rating or grading system; etc.).

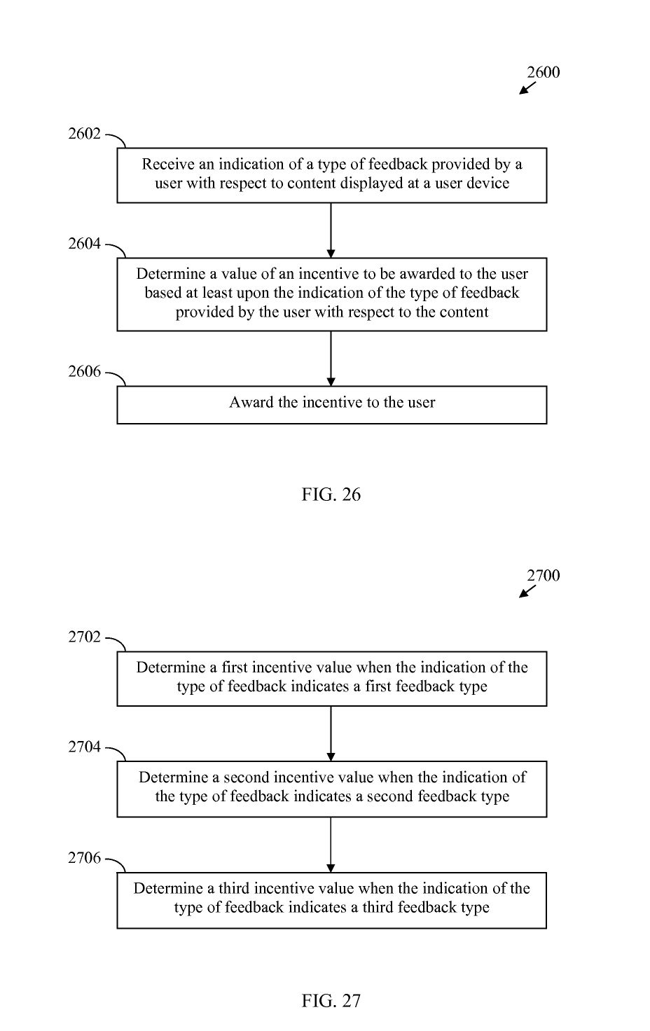

FIG. 26 depicts a flowchart 2600 of a method by which server 2504 may operate to determine a value of an incentive based upon a type of content feedback provided by a user and to award the incentive to the user. Although the method of flowchart 2600 will now be described with continued reference to components of incentive system 2500, persons skilled in the relevant arts) will appreciate that the method may be implemented by other components or systems.

As shown in FIG. 26, the method of flowchart 2600 begins at step 2602, in which an indication of a type of feedback provided by a user with respect to content displayed at a user device is received. This step may be performed, for example, by network interface 2512 of server 2504 when network interface 2512 receives feedback measures signal 2536. As was previously described, feedback measures signal 2536 may include an indication of how many instances of each of a plurality of predefined feedback types the user has provided with respect to various items of content over a certain time period. However this is only an example, and the indication received during step 2602 may be represented in other forms. For example, the indication received during step 2602 may simply indicate that the user has provided a particular type of feedback with respect to a single item of content.

At step 2604, a value of an incentive to be awarded to the user is determined based at least upon the indication of the type of feedback provided by the user with respect to the content. This step may be performed, for example, by evaluation engine 2540.

At step 2606, the incentive is awarded to the user. This step may also be performed, for example, by evaluation engine 2540. Evaluation engine 2540 may award the incentive to the user by assigning the incentive to a user account associated with the user. However, the awarding of the incentive to the user may be carried out using other techniques as well. For example, the incentive itself or information sufficient to redeem the incentive may simply be sent to the user via any one of a variety of physical or digital communication channels.

As noted above, the value of the incentive determined during step 2604 is determined based at least upon the indication of the type of feedback provided by the user with respect to the content. In one embodiment, a different incentive value is determined depending on the type of feedback that was provided by the user. For example, in an embodiment in which there are three feedback types comprising “No,” “More” and “Deep,” an instance of “Deep” feedback may result in the assignment of a greater incentive value than an instance of “More” feedback, and an instance of “More” feedback may result in the assignment of a greater incentive value than an instance of “No” feedback. One reason for valuing the feedback in this manner is that “Deep” feedback is likely to be more valuable than “More” feedback in determining a user's preferences, and “More” feedback is likely to be more valuable than “No” feedback” in determining the user's preferences. For example, when a user provides a feedback of “Deep,” the system can determine exactly what the user likes and deliver the precise content in which the user is interested. When a user provides a feedback of “More,” the system can obtain a better sense of what the user likes at some level of generality (e.g., category or topic) and can therefore fetch new content in which the user is likely to be interested. When a user provides a feedback of “No,” the system can only exclude content that the user doesn't like but gains only limited knowledge about what the user does like. In every case, the knowledge obtained through feedback can be used to model the preferences of the user and such model may be stored in a user profile for later use.

In an embodiment in which the incentives comprise credits that accrue to a user account, a different multiplier or coefficient may be assigned to each feedback type. The coefficient for a particular feedback type can be multiplied by the number of instances of the particular feedback type provided by the user over a certain time period (as conveyed in feedback measures signal 2536) to determine a number of credits that should be added to the user's user account. A scheme such as that shown below in Table 1 may be used to evaluate the number of credits to be awarded.

TABLE 1

| Behavior | Coefficient | Explanation |
|---|---|---|
| No | 1x | When user selects “No,” the system can only |
| | | exclude content the user does not like but has |
| | | limited knowledge about what the user does |
| | | like |
| More | 2x | When user selects “More,” the system has a |
| | | better knowledge of what the user likes and |
| | | can fetch new content in which the user is |
| | | likely to be interested |
| Deep | 3x | When user selects “Deep,” the system can |
| | | determine exactly what the user likes and |
| | | deliver the precise content in which the user |
| | | is interested |

For example, in accordance with the scheme shown in Table 1, if the measures received as part of feedback measures signal 2536 indicate that a user has provided 7 “No” types of feedback, 3 “More” types of feedback, and 1 “Deep” type of feedback during a particular time period, evaluation engine 2540 may determine that the user should be awarded (1×7)+(2×3)+(3×1)=16 credits. Of course, this scheme is provided by way of example only. Persons skilled in the relevant art(s) will appreciate that any number of schemes may be developed to determine the value of an incentive based on feedback type.

To further illustrate some of the foregoing concepts, FIG. 27 depicts a flowchart of a method 2700 for determining a value of an incentive to be awarded to a user based at least upon on indication of a type of feedback provided by the user with respect to content. In one embodiment, the method of flowchart 2700 is performed by evaluation engine 2540 within system 2500. However, persons skilled in the relevant art(s) will appreciate that the method may be implemented by other components or systems.

As shown in FIG. 27, the method of flowchart 2700 begins at step 2702 in which a first incentive value is determined when the indication of the type of feedback indicates a first feedback type. By way of example, a first incentive value may be determined when the indication of the type of feedback indicates a “No” feedback type.

At step 2704, a second incentive value is determined when the indication of the type of feedback indicates a second feedback type. By way of example, a second incentive value may be determined when the indication of the type of feedback indicates a “More” feedback type.

At step 2706, a third incentive value is determined when the indication of the type of feedback indicates a third feedback type. By way of example, a third incentive value may be determined when the indication of the type of feedback indicates a “Deep” feedback type.

In an embodiment, the third incentive value is greater than the second incentive value and the second incentive value is greater than the first incentive value. Thus, in accordance with this embodiment and the specific examples mentioned above, the third incentive value assigned to the “Deep” type of feedback exceeds the value of the second incentive value assigned to the “More” type of feedback, and the second incentive value assigned to the “More” type of feedback exceeds the value of the first incentive value assigned to the “No” type of feedback. One way of achieving the foregoing in an embodiment in which the incentive comprises credits is to multiply the instance of feedback by a coefficient wherein the coefficient assigned to “Deep” feedback is larger than the coefficient assigned to “More” feedback, and the coefficient assigned to “More” feedback is larger than the coefficient assigned to “No” feedback. Such an approach was described above in reference to Table 1.

In a further embodiment, evaluation engine 2540 determines the value of an incentive to be awarded to the user based on a type of feedback provided by the user with respect to various items of content and a category associated with each item of content about which the feedback was provided. That is to say, the value of the incentive that will be awarded to a user will vary based on the type of feedback that the user has provided with respect to various items of content and a category associated with each item of content about which the feedback was provided. For this to occur, the feedback provided by the user with respect to content must be classifiable into one of a plurality of predefined feedback types (e.g., “No,” “More” and “Deep” as was previously discussed) and the content items about which feedback was provided must also be classifiable into a plurality of categories. For example, the content items may be classifiable into any number of categories such as “news,” “consumer products,” “automobiles,” “technology,” “luxury,” “autos,” and the like. However, these are only some examples, and content items may be classified into a wide variety of other arbitrarily-defined categories.

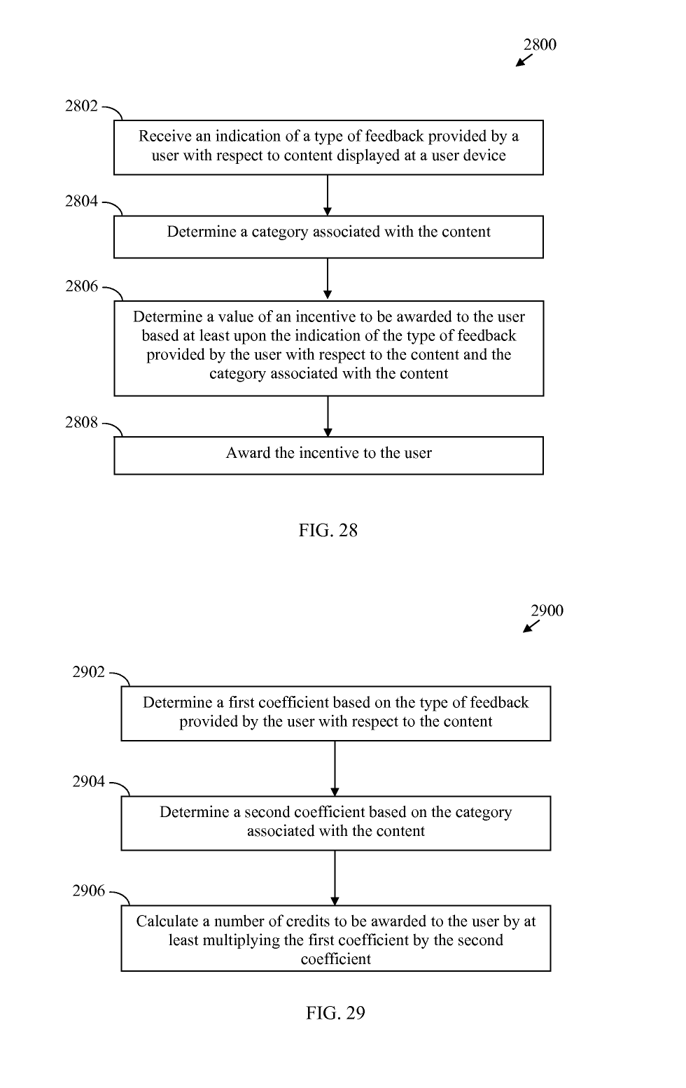

FIG. 28 depicts a flowchart 2800 of a method by which server 2504 may operate to determine a value of an incentive based upon a type of feedback provided by a user with respect to content and a category associated with the content and to award the incentive to the user. Although the method of flowchart 2800 will now be described with continued reference to components of incentive system 2500, persons skilled in the relevant art(s) will appreciate that the method may be implemented by other components or systems.

As shown in FIG. 28, the method of flowchart 2800 begins at step 2802, in which an indication of a type of feedback provided by a user with respect to content displayed at a user device is received. This step may be performed, for example, by network interface 2512 of server 2504 when network interface 2512 receives feedback measures signal 2536. As was previously described, feedback measures signal 2536 may include an indication of how many instances of each of a plurality of predefined feedback types the user has provided with respect to various items of content over a certain time period. However this is only an example, and the indication received during step 2802 may be represented in other forms. For example, the indication received during step 2802 may simply indicate that the user has provided a particular type of feedback with respect to a single item of content.

At step 2804, a category associated with the content about which feedback was provided by the user is determined. This step may be performed, for example, by evaluation engine 2540. The category associated with the content may be determined in a number of ways. For example, in one embodiment, the category or an indication thereof may be received as part of feedback measures signal 2536 (i.e., agent 2532 may include the category type or an indication thereof in the information that it reports to server 2504). In another embodiment, evaluation engine 2540 or some other component of server 2504 may identify the content about which feedback is being provided and apply a classification algorithm to it so as to determine the appropriate category. However, these examples are not intended to be limiting and still other techniques may be used to determine the category associated with the content.

At step 2806, a value of an incentive to be awarded to the user is determined based at least upon the indication of the type of feedback provided by the user with respect to the content and the category associated with the content. This step may be performed, for example, by evaluation engine 2540.

At step 2808, the incentive is awarded to the user. This step may also be performed, for example, by evaluation engine 2540. Evaluation engine 2540 may award the incentive to the user by assigning the incentive to a user account associated with the user. However, the awarding of the incentive to the user may be carried out using other techniques as well. For example, the incentive itself or information sufficient to redeem the incentive may simply be sent to the user via any one of a variety of physical or digital communication channels.

As noted above, the value of the incentive determined during step 2806 is determined based at least upon the indication of the type of feedback provided by the user with respect to the content and the category associated with the content. As was previously discussed, in an embodiment in which there are three feedback types comprising “No,” “More” and “Deep,” each feedback type may result in the assignment of a different incentive value. In the embodiment described in flowchart 2800, the incentive value is further determined based on the category about which feedback was provided, wherein different categories are associated with different award values. This approach may be used when obtaining user feedback about one category of content is more valuable to a content provider than obtaining user feedback about another category of content. For example, obtaining feedback about luxury items and automobiles may be more valuable to a content provider than obtaining feedback about entertainment or sports content, because the content provider may be able to generate more ad revenue by targeting ads to users who like luxury items and automobiles than targeting ads to users who like entertainment and sports.

In an embodiment in which the incentives comprise credits that accrue to a user account, a first multiplier or coefficient may be assigned to each feedback type (as was discussed above in reference to Table 1) and a second multiplier or coefficient may be assigned to each content category. For example, a scheme such as that shown below in Table 2 may be used to determine the coefficient for each category of content.

TABLE 2

| Category | Coefficient | Explanation |
|---|---|---|
| Luxury | 1.5x | High value for content provider |
| Autos | 1.2x | Intermediate value for content provider |
| Sports | 1x | Low value for content provider |

To determine a number of credits that should be added to the user's user account, the number of instances of a particular feedback type with respect to a particular category of content provided by a user over a certain time period can be multiplied by the coefficient for the particular feedback type and the coefficient for the particular category. Thus, for example, if a user provided 4 “No” types of feedback with respect to content items in the luxury items category during a particular time period, evaluation engine 2540 may determine that the user should be awarded (1×1.5×4)=6 credits. As another example, if a user provided 1 “Deep” type of feedback with respect to a content item in the sports category during a particular time period, evaluation engine 2540 may determine that the user should be awarded (4×1×1)=4 credits. Of course, this scheme is provided by way of example only. Persons skilled in the relevant art(s) will appreciate that any number of schemes may be developed to determine the value of an incentive based on feedback type and content category.

To further illustrate some of the foregoing concepts, FIG. 29 depicts a flowchart of a method 2900 for determining a value of an incentive to be awarded to a user based at least upon on indication of a type of feedback provided by the user with respect to content and a category associated with the content. In one embodiment, the method of flowchart 2900 is performed by evaluation engine 2540 within system 2500. However, persons skilled in the relevant art(s) will appreciate that the method may be implemented by other components or systems.

As shown in FIG. 29, the method of flowchart 2900 begins at step 2902 in which a first coefficient is determined based on the type of feedback provided by the user with respect to the content. By way of example only, the first coefficient may be determined in accordance with Table 1 above which maps each of a “No,” “More” and “Deep” feedback type to a corresponding coefficient.

At step 2904, a second coefficient is determined based on the category associated with the content. By way of example only, the second coefficient may be determined in accordance with Table 2 above which maps each of a “Luxury,” “Autos” and “Sports” content category to a corresponding coefficient.

At step 2906, a number of credits to be awarded to the user is calculated by at least multiplying the first coefficient by the second coefficient. For example, the number of credits to be awarded to the user may be calculated by multiplying the first coefficient (which corresponds to a particular feedback type) by the second coefficient (which corresponds to a particular content category) by the number of times the user provided that particular feedback type in the particular content category. Once the number of credits has been calculated, evaluation engine 2540 may add the credits to an accumulated number of credits associated with the user's user account.

Evaluation engine 2540 may take other factors into account when determining the value of incentives to be awarded to a user. For example, in one embodiment, evaluation engine 2540 may place a limit on the total number of credits that can be added to the user's user account in a given time period (e.g., hour, day, month, etc.). For example, evaluation engine 2540 may enforce a 100 credit/day limit such that a user may not add more than 100 additional credits to their account in a day.

Evaluation engine 2540 may also operate to assign an incentive step level to the user based at least on the accumulated number of credits associated with the user's user account. The incentive step level may be used to determine a rate at which credits are accumulated to the user account. For example, when a user has earned a certain number of credits, evaluation engine 2540 may promote the user from a first incentive step level to a second incentive step level, wherein membership in the second incentive step level enables the user to accumulate credits at a faster rate than the user could in the first incentive step level. Different step levels may be given different titles, such as “bronze,” “silver,” “gold” and “platinum” to help users distinguish among them.

### IV. Example User Device and Server Embodiments

Each of the components of user device 102, server 104, server 500, user device 2502, and server 2504, and each of the steps of the flowcharts shown in FIGS. 2, 3, 6-10 and 26-29, may be implemented in hardware, or hardware combined with software and/or firmware. For example, one or more of the components of user device 102, server 104, server 500, user device 2502, and server 2504, and one or more of the steps of the flowcharts shown in FIGS. 2, 3, 6-10 and 26-29 may be implemented as computer program code/instructions configured to be executed in one or more processors and stored in a computer readable storage medium. Furthermore, one or more of the components of user device 102, server 104, server 500, user device 2502, and server 2504, and one or more of the steps of the flowcharts shown in FIGS. 2, 3, 6-10 and 26-29 may be implemented as hardware logic/electrical circuitry.

For instance, in an embodiment, one or more of the components of user device 102, server 104, server 500, user device 2502, and server 2504, and one or more of the steps of the flowcharts shown in FIGS. 2, 3, 6-10 and 26-29 may be implemented in a system-on-chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and optionally embedded firmware to perform its functions.

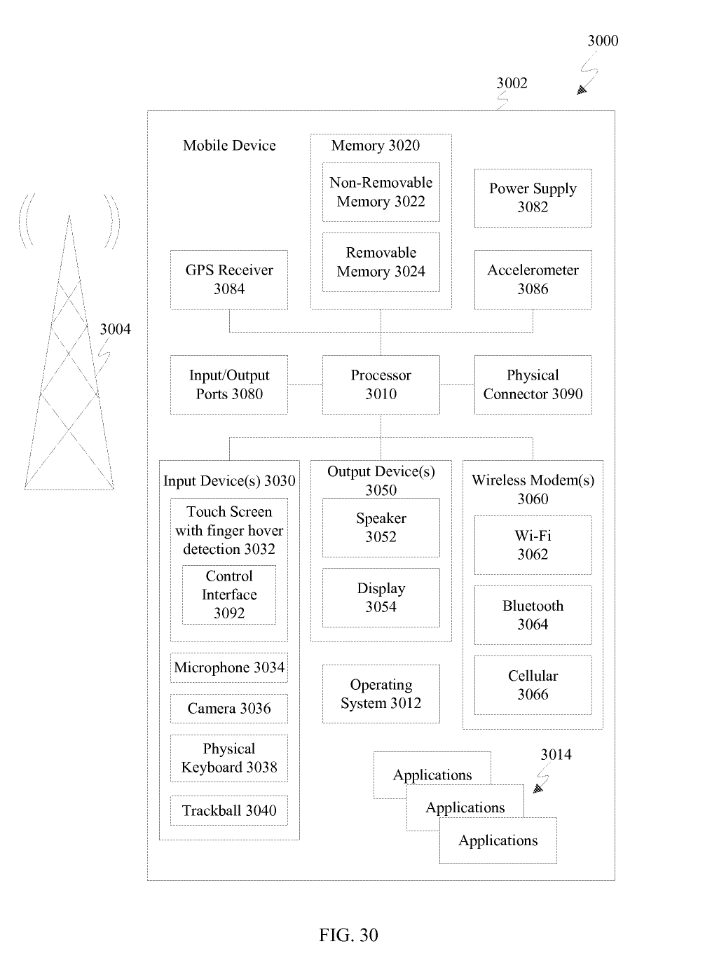

FIG. 30 shows a block diagram of an exemplary mobile device 3000 including a variety of optional hardware and software components, shown generally as components 3002. For instance, components 3002 of mobile device 3000 are examples of components that may be included in user device 102 (FIG. 1) and user device 2502 (FIG. 25) in mobile device embodiments, but are not shown in the respective figures for ease of illustration. Any number and combination of the features/elements of components 3002 may be included in a mobile device embodiment, as well as additional and/or alternative features/elements, as would be known to persons skilled in the relevant art(s). It is noted that any of components 3002 can communicate with any other of components 3002, although not all connections are shown, for ease of illustration. Mobile device 3000 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 3004, such as a cellular or satellite network, or with a local area or wide area network.

The illustrated mobile device 3000 can include a controller or processor 3010 (e.g., signal processor, microprocessor, ASIC, or other control and processing logic circuitry) for performing such tasks as signal coding, data processing, input/output processing, power control, and/or other functions. An operating system 3012 can control the allocation and usage of components 3002 and support for one or more application programs 3014 (a.k.a. applications, “apps”, etc.). Application programs 3014 can include common mobile computing applications (e.g., email applications, calendars, contact managers, web browsers, messaging applications) and any other computing applications (e.g., word processing applications, mapping applications, media player applications).

As illustrated, mobile device 3000 can include memory 3020. Memory 3020 can include non-removable memory 3022 and/or removable memory 3024. Non-removable memory 3022 can include RAM, ROM, flash memory, a hard disk, or other well-known memory storage technologies. Removable memory 3024 can include flash memory or a Subscriber Identity Module (SIM) card, which is well known in GSM communication systems, or other well-known memory storage technologies, such as “smart cards.” Memory 3020 can be used for storing data and/or code for running operating system 3012 and applications 3014. Example data can include web pages, text, images, sound files, video data, or other data sets to be sent to and/or received from one or more network servers or other devices via one or more wired or wireless networks. Memory 3020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of program modules may be stored in memory 3020. These programs include operating system 3012, one or more application programs 3014, and other program modules and program data. Examples of such application programs or program modules may include, for example, computer program logic (e.g., computer program code or instructions) for implementing one or more of the components of user device 102 or user device 2502, or one or more steps of the flowcharts of FIGS. 2 and 3 and/or further embodiments described herein.

Mobile device 3000 can support one or more input devices 3030, such as a touch screen 3032, microphone 3034, camera 3036, physical keyboard 3038 and/or trackball 3040 and one or more output devices 3050, such as a speaker 3052 and a display 3054. Touch screens, such as touch screen 3032, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 3032 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

Touch screen 3032 is shown to include a control interface 3092 for illustrative purposes. Control interface 3092 is configured to control content associated with a virtual element that is displayed on touch screen 3032. In an example embodiment, control interface 3092 is configured to control content that is provided by one or more of applications 3014. For instance, when a user of mobile device 3000 utilizes an application, control interface 3092 may be presented to the user on touch screen 3032 to enable the user to access controls that control such content. Presentation of control interface 3092 may be based on (e.g., triggered by) detection of a motion within a designated distance from the touch screen 3032 or absence of such motion.

Other possible output devices (not shown) can include piezoelectric or other haptic output devices. Some devices can serve more than one input/output function. For example, touch screen 3032 and display 3054 can be combined in a single input/output device. Input devices 3030 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, operating system 3012 or applications 3014 can comprise speech-recognition software as part of a voice control interface that allows a user to operate device 3000 via voice commands. Further, device 3000 can comprise input devices and software that allows for user interaction via a user's spatial gestures, such as detecting and interpreting gestures to provide input to a gaming application.

Wireless modem(s) 3060 can be coupled to antenna(s) (not shown) and can support two-way communications between processor 3010 and external devices, as is well understood in the art. Modem(s) 3060 are shown generically and can include a cellular modem 3066 for communicating with mobile communication network 3004 and/or other radio-based modems (e.g., Bluetooth 3064 and/or Wi-Fi 3062). Cellular modem 3066 may be configured to enable phone calls (and optionally transmit data) according to any suitable communication standard or technology, such as GSM, 3G, 4G, 5G, etc. At least one of wireless modem(s) 3060 is typically configured for communication with one or more cellular networks, such as a GSM network for data and voice communications within a single cellular network, between cellular networks, or between the mobile device and a public switched telephone network (PSTN).

Mobile device 3000 can further include at least one input/output port 3080, a power supply 3082, a satellite navigation system receiver 3084, such as a Global Positioning System (GPS) receiver, an accelerometer 3086, and/or a physical connector 3090, which can be a USB port, IEEE 1394 (FireWire) port, and/or RS-232 port. The illustrated components 3002 are not required or all-inclusive, as any components can be not present and other components can be additionally present as would be recognized by one skilled in the art.

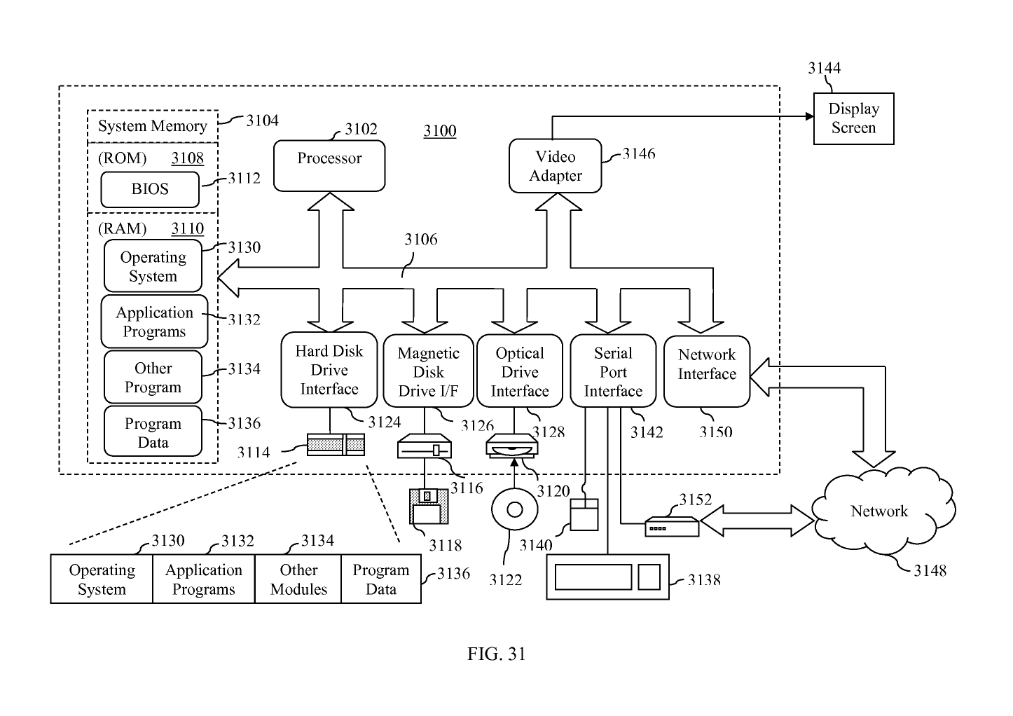

Furthermore, FIG. 31 depicts an exemplary implementation of a computing device 3100 in which embodiments may be implemented. For example, user device 102, user device 2502, server 104, server 500, or server 2504 may be implemented in one or more computing devices similar to computing device 3100 in stationary computer embodiments, including one or more features of computing device 3100 and/or alternative features. The description of computing device 3100 provided herein is provided for purposes of illustration, and is not intended to be limiting. Embodiments may be implemented in further types of computer systems, as would be known to persons skilled in the relevant art(s).

As shown in FIG. 31, computing device 3100 includes one or more processors 3102, a system memory 3104, and a bus 3106 that couples various system components including system memory 3104 to processor 3102. Bus 3106 represents one or more of any of several types of bus structures, including a memory bus or memory controller, a peripheral bus, an accelerated graphics port, and a processor or local bus using any of a variety of bus architectures. System memory 3104 includes read only memory (ROM) 3108 and random access memory (RAM) 3110. A basic input/output system 3112 (BIOS) is stored in ROM 3108.

Computing device 3100 also has one or more of the following drives: a hard disk drive 3114 for reading from and writing to a hard disk, a magnetic disk drive 3116 for reading from or writing to a removable magnetic disk 3118, and an optical disk drive 3120 for reading from or writing to a removable optical disk 3122 such as a CD ROM, DVD ROM, or other optical media. Hard disk drive 3114, magnetic disk drive 3116, and optical disk drive 3120 are connected to bus 3106 by a hard disk drive interface 3124, a magnetic disk drive interface 3126, and an optical drive interface 3128, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, RAMs, ROMs, and the like.

A number of program modules may be stored on the hard disk, magnetic disk, optical disk, ROM, or RAM. These programs include an operating system 3130, one or more application programs 3132, other program modules 3134, and program data 3136. These programs may include, for example, computer program logic (e.g., computer program code or instructions) for implementing one or more components of user device 102, user device 2502, server 104, server 500, and server 2504 and one or more steps of the flowcharts shown in FIGS. 2, 3, 6-10 and 26-29, and/or further embodiments described herein.

A user may enter commands and information into computing device 3100 through input devices such as a keyboard 3138 and a pointing device 3140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices may be connected to processor 3102 through a serial port interface 3142 that is coupled to bus 3106, but may be connected by other interfaces, such as a parallel port, game port, or a universal serial bus (USB).

A display screen 3144 is also connected to bus 3106 via an interface, such as a video adapter 3146. Display screen 3144 may be external to, or incorporated in computing device 3100. Display screen 3144 may display information, as well as being a user interface for receiving user commands and/or other information (e.g., by touch, finger gestures, virtual keyboard, etc.). In addition to display screen 3144, computing device 3100 may include other peripheral output devices (not shown) such as speakers and printers.

Computing device 3100 is connected to a network 3148 (e.g., the Internet) through an adaptor or network interface 3150, a modem 3152, or other means for establishing communications over the network. Modem 3152, which may be internal or external, may be connected to bus 3106 via serial port interface 3142, as shown in FIG. 31, or may be connected to bus 3106 using another interface type, including a parallel interface.

As used herein, the terms “computer program medium,” “computer-readable medium,” and “computer-readable storage medium” are used to generally refer to media such as the hard disk associated with hard disk drive 3114, removable magnetic disk 3118, removable optical disk 3122, system memory 3104, flash memory cards, digital video disks, RAMs, ROMs, and further types of physical/tangible storage media. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 3132 and other program modules 3134) may be stored on the hard disk, magnetic disk, optical disk, ROM, or RAM. Such computer programs may also be received via network interface 3150, serial port interface 3142, or any other interface type. Such computer programs, when executed or loaded by an application, enable computing device 3100 to implement features of embodiments discussed herein. Accordingly, such computer programs represent controllers of the computing device 3100.

As such, embodiments are also directed to computer program products comprising computer instructions/code stored on any computer useable storage medium. Such code/instructions, when executed in one or more data processing devices, causes a data processing device(s) to operate as described herein. Examples of computer-readable storage devices that may include computer readable storage media include storage devices such as RAM, hard drives, floppy disk drives, CD ROM drives, DVD ROM drives, zip disk drives, tape drives, magnetic storage device drives, optical storage device drives, MEMs devices, nanotechnology-based storage devices, and further types of physical/tangible computer readable storage devices.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
receiving an indication of a type of feedback provided by a user with respect to content displayed at a user device;
determining a value of an incentive to be awarded to the user based at least upon the indication of the type of feedback provided by the user with respect to the content; and
awarding the incentive to the user.

2. The method of claim 1, wherein the type of feedback provided by the user comprises one of a plurality of predefined feedback types, the plurality of predefined feedback types including:
a first feedback type that indicates that the user does not like the content;
a second feedback type that indicates that the user likes the content and wants to see additional content that is topically related thereto; and
a third feedback type that indicates that the user likes the content and wants to see additional information about the content or conduct at least one transaction with respect to the content.

3. The method of claim 2, wherein determining the value of the incentive comprises:
determining a first incentive value when the indication of the type of feedback indicates the first feedback type;
determining a second incentive value when the indication of the type of feedback indicates the second feedback type; and
determining a third incentive value when the indication of the type of feedback indicates the third feedback type;
wherein the third incentive value is greater than the second incentive value and the second incentive value is greater than the first incentive value.

4. The method of claim 1, wherein determining the value of the incentive comprises:
determining the value of the incentive based at least upon the indication of the type of feedback provided by the user with respect to the content and a category associated with the content.

5. The method of claim 4, wherein determining the value of the incentive based at least upon the indication of the type of feedback provided by the user with respect to the content and the category associated with the content comprises:
determining a first coefficient based on the type of feedback provided by the user with respect to the content;
determining a second coefficient based on the category associated with the content; and
calculating a number of credits to be awarded to the user by at least multiplying the first coefficient by the second coefficient.

6. The method of claim 1, wherein awarding the incentive to the user comprises:
adding one or more credits to an accumulated number of credits associated with a user account.

7. The method of claim 6, further comprising:
maintaining a limit on a number of credits that can be added to the accumulated number of credits associated with the user account in a particular time period.

8. The method of claim 6, further comprising:
assigning an incentive step level to the user based at least on the accumulated number of credits associated with the user account, the incentive step level being used to determine a rate at which credits are accumulated to the user account.

9. The method of claim 6, further comprising:
providing an interface by which the user can redeem the credits associated with the user account to obtain one or more items of value.

10. The method of claim 1, further comprising:
modeling preferences of the user based at least on the indication of the type of feedback provided by the user with respect to the content.

11. A system, comprising:
a network interface operable to receive an indication of a type of feedback provided by a user with respect to content displayed at a user device;
an evaluation engine operable to determine a value of an incentive to be awarded to the user based at least upon the indication of the type of feedback provided by the user with respect to the content and to award the incentive to the user.

12. The system of claim 11, wherein the type of feedback provided by the user comprises one of a plurality of predefined feedback types, the plurality of predefined feedback types including:
a first feedback type that indicates that the user does not like the content;
a second feedback type that indicates that the user likes the content and wants to see additional content that is topically related thereto; and
a third feedback type that indicates that the user likes the content and wants to see additional information about the content or conduct at least one transaction with respect to the content.

13. The system of claim 11, wherein the evaluation engine is operable to determine the value of the incentive by:
determining a first incentive value when the indication of the type of feedback indicates the first feedback type;
determining a second incentive value when the indication of the type of feedback indicates the second feedback type; and
determining a third incentive value when the indication of the type of feedback indicates the third feedback type;
wherein the third incentive value is greater than the second incentive value and the second incentive value is greater than the first incentive value.

14. The system of claim 11, wherein the evaluation engine is operable to determine the value of the incentive based at least upon the indication of the type of feedback provided by the user with respect to the content and a category associated with the content.

15. The system of claim 14, wherein the evaluation engine is operable to determine the value of the incentive based at least upon the indication of the type of feedback provided by the user with respect to the content and the category associated with the content by:
determining a first coefficient based on the type of feedback provided by the user with respect to the content;
determining a second coefficient based on the category associated with the content; and
calculating a number of credits to be awarded to the user by at least multiplying the first coefficient by the second coefficient.

16. The system of claim 11, wherein the evaluation engine is operable to award the incentive to the user by:
adding one or more credits to an accumulated number of credits associated with a user account.

17. The system of claim 16, wherein the evaluation engine is further operable to maintain a limit on a number of credits that can be added to the accumulated number of credits associated with the user account in a particular time period.

18. The system of claim 16, wherein the evaluation engine is further operable to assign an incentive step level to the user based at least on the accumulated number of credits associated with the user account, the incentive step level being used to determine a rate at which credits are accumulated to the user account.

19. The system of claim 16, further comprising:
a redemption engine operable to provide an interface by which the user can redeem the credits associated with the user account to obtain one or more items of value.

20. A computer-readable storage medium comprising computer-executable instructions that, when executed by a processor, perform a method comprising:
receiving an indication of a type of feedback provided by a user with respect to content displayed at a user device;
determining a category associated with the content;
determining a value of an incentive based at least upon the indication of the type of feedback provided by the user with respect to the content and the category associated with the content; and
awarding the incentive to the user.
